(19) United States
(12) Patent Application Publication
(10) Pub. No.: US 2025/0282586 A1
(43) Pub. Date: Sep. 11, 2025

(54) PALLET LIFTING ASSEMBLY

(71) Applicant: DT Innovations LLC, Dover, OH (US)

(72) Inventors: Dylan Seats, Dover, OH (US); George Pahoundis, III, Cambridge, OH (US)

(73) Assignee: DT Innovations LLC, Dover, OH (US)

(21) Appl. No.: 19/069,664

(22) Filed: Mar. 4, 2025

Related U.S. Application Data
(60) Provisional application No. 63/561,431, filed on Mar. 5, 2024.

(51) Int. Cl. B66F 9/02; B66F 7/06

(52) U.S. Cl. CPC B66F 9/02; B66F 7/065

(57) ABSTRACT

A pallet lifting assembly and method thereof is provided for enabling the pallet lifting assembly to place a pallet atop an unmanned autonomous vehicle, such as an AMR or AGV. There is a pallet receiver positioned at or closely adjacent floor level, wherein the pallet receiver is configured to receive at least one pallet thereon and the pallet is adapted to support items thereon once received by the pallet receiver. There may be a guide system on the pallet receiver that accommodates different sized pallets. A lifting mechanism may raise the pallet receiver from floor level to a sufficient height that permits unmanned autonomous vehicle to move beneath the pallet receiver and the receiver be lowered to place the pallet atop the unmanned autonomous vehicle.

### CROSS REFERENCE TO RELATED APPLICATIONS

This application claims the benefit of U.S. Provisional Patent Application No. 63/561,431, filed Mar. 5, 2024; the entire specification of which is incorporated herein by reference.

### TECHNICAL FIELD

This disclosure relates generally to lifting assemblies for pallets.

### BACKGROUND ART

Pallets are a necessary component within a warehouse for shipping various goods around the world. In a typical warehouse, there are forklifts operated by a forklift operator. The forklift operator drives the forklift around the warehouse picking up and moving pallets. Forklifts are subject to human error and can be a danger within a warehouse. Further, forklifts cost a company more money as they have to hire personnel to operate the forklifts. In an attempt to make warehouses a safer place and cut down on costs, Autonomous Mobile Robots (AMRs) and/or Automated Guide Vehicles (AGVs) have been introduced within warehouses to assist with logistics transportation.

Many AMRs have a flat top, and their flat top may move up and down. Yet, the flat top is a few feet off the ground. The height of an AMR or AGV creates problems in lifting pallets because a forklift is still required to place a pallet on top of the AMR or AGV, therefore not eliminating any of the safety risks or costs of the forklift. A typical pallet jack further does not remediate the issue because a pallet jack may only lift a pallet a few inches and does not raise a pallet high enough to be loaded on to the flat top of an AMR or AGV.

### SUMMARY OF THE INVENTION

The present disclosure aims to remediate this issue by allowing a pallet to be loaded onto a pallet lifting assembly at floor level or closely adjacent to the floor level. The pallet lifting assembly is a assembly that any warehouse could have on site, and it may eliminate the need for forklifts to drive around the warehouse to take a pallet from one location to another. The pallet lifting assembly provides a floor level receiver that is adapted to receive a pallet at floor level, then rise up to the height needed to load an AMR or AGV (e.g., generally referred to as an unmanned autonomous vehicle) by having a lifting mechanism on the side of the receiver or on the back of the receiver. By having the lifting mechanism on the side of the receiver or on the back of the receiver, the pallet lifting assembly is adapted to receive an AMR or AGV underneath so that the receiver can set the pallet down on the flat top and the AMR or AGV can self-drive the pallet to a desired location.

In one aspect, an exemplary embodiment of the present disclosure may provide an assembly for raising a pallet, wherein the pallet lifting assembly includes; a rigid receiver, wherein the receiver is generally U-shaped; a guide system to accommodate different sized pallets, wherein the guide system includes at least a first wall section and a second wall section; and a lifting mechanism, wherein the lifting mechanism is located on the perimeter of the rigid receiver.

In another aspect, an exemplary embodiment of the present disclosure may provide a trolley system, wherein the trolley system is located on the perimeter of the rigid receiver.

In one aspect, an exemplary embodiment of the present disclosure may provide a method of lifting a pallet, comprising: placing a pallet on to a rigid receiver; fitting the pallet on the rigid receiver by using a guide system that abuts the pallet and can accommodate different sized pallets, wherein the pallet may rest on at least one wall of the guide system; lifting the pallet with a lifting mechanism to a desired height to allow the pallet to be relocated.

In yet another aspect, an exemplary embodiment of the present disclosure may include a pallet lifting assembly comprising: a pallet receiver positioned at or closely adjacent floor level, wherein the pallet receiver is configured to receive at least one pallet thereon, wherein the pallet is adapted to support items thereon once received by the pallet receiver; a guide system on the pallet receiver that is selectively adjustable to accommodate different sized pallets; and a lifting mechanism to raise the pallet receiver from floor level to a sufficient height that permits unmanned autonomous vehicle to move beneath the pallet receiver and the receiver be lowered to place the pallet atop the unmanned autonomous vehicle. This exemplary embodiment or another exemplary embodiment may further provide that the lifting mechanism is located at a perimeter of the pallet receiver. This exemplary embodiment or another exemplary embodiment may further include a pegboard surface on the pallet receiver, wherein the pegboard surface has a number of apertures defined in the pallet receiver, wherein the apertures extend from a top surface of the pallet receiver toward a bottom surface of the pallet receiver. This exemplary embodiment or another exemplary embodiment may further provide that the guide system includes at least a first wall section and a second wall section that are oriented at a right angle relative to each other and define a corner brace that is configured to receive a corner of the pallet therebetween. This exemplary embodiment or another exemplary embodiment may further provide that the corner brace comprises at least two prongs, wherein the two prongs extend downwardly from a bottom surface of the corner brace. This exemplary embodiment or another exemplary embodiment may further provide that the at least two prongs have a generally cylindrical shape, wherein a diameter of each prong is marginally less than a diameter of the apertures on the pegboard surface such that the prongs are configured to fit in the apertures to attach the corner brace to the pegboard surface. This exemplary embodiment or another exemplary embodiment may further include a trolley; and at least one rail that extends vertically upward relative to the pallet receiver that is oriented flat at or near floor level, wherein the trolley rides along the at least one rail as the pallet receiver is raised and lowered. This exemplary embodiment or another exemplary embodiment may further include a second trolley; and a second rail that extends vertically upward relative to the receiver that is oriented flat at or near floor level, wherein the second trolley rides along the second rail as the pallet receiver is raised and lowered. This exemplary embodiment or another exemplary embodiment may further provide that the pallet receiver is U-shaped and composed of first and second parallel legs and a rear leg that extends between the first and second parallel legs, and the trolley and the first rail are positioned adjacent the rear leg of the pallet receiver. This exemplary embodiment or another exemplary embodiment may further provide that the guide system further comprises at least one retention brace. This exemplary embodiment or another exemplary embodiment may further provide that the at least one retention brace comprises: a first wall section; and a second wall section, wherein the first wall section and the second wall section are connected and orthogonal to one another and wherein the first wall section and the second wall section differ in length. This exemplary embodiment or another exemplary embodiment may further include a third wall section that is connected to the second wall section; and a fourth wall section, wherein the third wall section and the fourth wall section are connected and orthogonal to one another and wherein the third wall section and the fourth wall section differ in length. This exemplary embodiment or another exemplary embodiment may further include a fifth wall section that is connected to the fourth wall section; and a sixth wall section wherein the fifth wall section and the sixth wall section are connected and orthogonal to one another and wherein the fifth wall section and the sixth wall section differ in lengths; a seventh wall section connected to the sixth wall section; an eighth wall section wherein the seventh wall section and the eighth wall section are connected and orthogonal to one another and wherein the seventh wall section and the eighth wall section differ in length; and a ninth wall section that connected to the eighth wall section and is at an angle between about 90 degrees and about 180 degrees relative to the eighth wall section. This exemplary embodiment or another exemplary embodiment may further provide that the at least one retention brace is in a fixed position on a top surface of the pallet receiver.

In yet another aspect, an exemplary embodiment of the present disclosure may provide a method for lifting a pallet onto an unmanned autonomous vehicle, the method comprising: placing a pallet on a pallet receiver that is at or near floor level; abutting a corner of the pallet with a guide system on the pallet receiver; raising the pallet receiver to lift the pallet from a lowered position to a raised position; effecting an unmanned autonomous vehicle to move beneath the raised pallet receiver; lowering the pallet receiver to place the pallet atop the unmanned autonomous vehicle; and effecting the unmanned autonomous vehicle to drive to another location while carrying the pallet that has been placed thereon. This exemplary embodiment or another exemplary embodiment may further include selectively adjusting the guide system prior to placing the pallet on the pallet receiver, wherein adjusting the guide system is accomplished by inserting at least two prongs of a corner brace of the guide system into a pegboard surface on the rigid receiver. This exemplary embodiment or another exemplary embodiment may further include contacting the corner of the pallet with two orthogonal walls of differing length that in a fixed position on a top surface of the pallet receiver. This exemplary embodiment or another exemplary embodiment may further include moving a trolley along a rail that are in operative communication with the pallet receiver as the pallet received is raised and lowered. This exemplary embodiment or another exemplary embodiment may further include moving a set of jacks that are located on each side of the pallet receiver. This exemplary embodiment or another exemplary embodiment may further include rotating a threaded drive rod that is vertically oriented and located near a perimeter of the pallet receiver.

In yet another aspect, an exemplary embodiment of the present disclosure may provide a method of lifting a pallet comprising: placing a pallet on a rigid receiver; fitting the pallet on the rigid receiver by using a guide system that abuts the pallet and can accommodate different sized pallets, wherein the pallet may rest on at least one wall of the guide system; lifting the pallet with a lifting mechanism to a desired height to allow the pallet to be relocated; and relocating the pallet. This exemplary embodiment or another exemplary embodiment may further include inserting at least two prongs of a corner brace of the guide system into a pegboard surface on the rigid receiver. This exemplary embodiment or another exemplary embodiment may further include placing a pallet on a lifting region of the rigid receiver. This exemplary embodiment or another exemplary embodiment may further include initiating a motor in operative communication with a trolley, wherein the motor on the trolley is rotating and gliding a set of wheels along a rail to raise the rigid receiver with the pallet on the lifting region of the rigid receiver. This exemplary embodiment or another exemplary embodiment may further include gliding a second set of wheels along a second rail to raise the rigid receiver with the pallet on the lifting region of the rigid receiver. This exemplary embodiment or another exemplary embodiment may further include raising the rigid receiver to a height, wherein the rigid receiver lowers a bottom surface of the pallet on to a top surface of an autonomous vehicle. This exemplary embodiment or another exemplary embodiment may further include raising the rigid receiver by a set of jacks, wherein the jacks are connected to a motor and the motor raises the set of jacks to a height. This exemplary embodiment or another exemplary embodiment may further include lowering the pallet to a resting position by turning the motor in an opposite direction, wherein the pallet reaches a floor surface when lowered.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is a top isometric view of a first embodiment of the pallet lifting assembly.

FIG. 2A is a front perspective view of a corner brace.

FIG. 2B is a bottom perspective view of a corner brace.

FIG. 3 is a partially exploded top isometric view of the first embodiment of the pallet lifting assembly depicting the selective installation of the pin system.

FIG. 4 is a partial exploded top isometric view of the first embodiment of the pallet lifting assembly, shown with the electronic jacks separated from the cover.

FIG. 5 is a top plan view of the first embodiment of the pallet lifting assembly.

FIG. 6 is a cross section view of the lifting jack taken along line 6-6 in FIG. 5.

FIG. 7A is an operational top plan view of the pin system being selectively positioned for a pallet to rest on the U-shaped receiver.

FIG. 7B is an operational top plan view of the pallet abutting the pin system and resting on the lifting surface of the U-shaped receiver.

FIG. 7C is another operational top plan view, similar to FIG. 7A, but the pin system being selectively positioned to receive a second pallet of a different size to rest on the U-shaped receiver.

FIG. 7D is another operational top plan view, similar to FIG. 7A and FIG. 7C, but the pin system is being selectively positioned to receive a third pallet of a different size to rest on the U-shaped receiver.

FIG. 8A is an operational side elevation view of items being loaded onto the pallet.

FIG. 8B is a side elevation view of items on a pallet that are being raised by the pallet lifting assembly.

FIG. 8C is an operational side elevation view, similar to FIG. 8B, wherein the pallet lifting assembly is fully raised and an AMR is moving towards the pallet lifting assembly.

FIG. 8D is an operational side elevation view of the AMR underneath the pallet lifting assembly.

FIG. 8E is a sectional plan view of the AMR underneath the pallet lifting assembly taken along line 8E-8E in FIG. 8D.

FIG. 8F is an operational side elevation view of the pallet lifting assembly either raising or lowering to place the pallet on the flat surface of the AMR.

FIG. 8G is a side elevation view of the AMR taking the pallet from the pallet lifting assembly to a different location.

FIG. 9 is a top isometric view of a second embodiment of the pallet lifting assembly.

FIG. 10 is a rear top isometric view of the second embodiment of the pallet lifting assembly.

FIG. 11 is a partial top plan view of a guide system of the second embodiment of the pallet lifting assembly.

FIG. 11A is a partial operational top plan view of the guide system of the second embodiment engaging with a pallet.

FIG. 11B is a partial operational top plan view of the guide system similar to FIG. 11A wherein, the guide system is selectively engaging with a pallet of a second size.

FIG. 12 is an operational rear top isometric view of the second embodiment of the pallet lifting assembly wherein the pallet lifting assembly is in a raised position.

FIG. 13 is a rear top isometric view of a third embodiment of the pallet lifting assembly.

FIG. 14 shows a partially exploded top perspective view depicting the selective installation of the guide system into the U-shaped receiver.

FIG. 15 is a method flowchart of using the pallet lifting assembly.

FIG. 16 is a second method flowchart of using the pallet lifting assembly.

Similar numbers refer to similar parts throughout the drawings.

### DETAILED DESCRIPTION

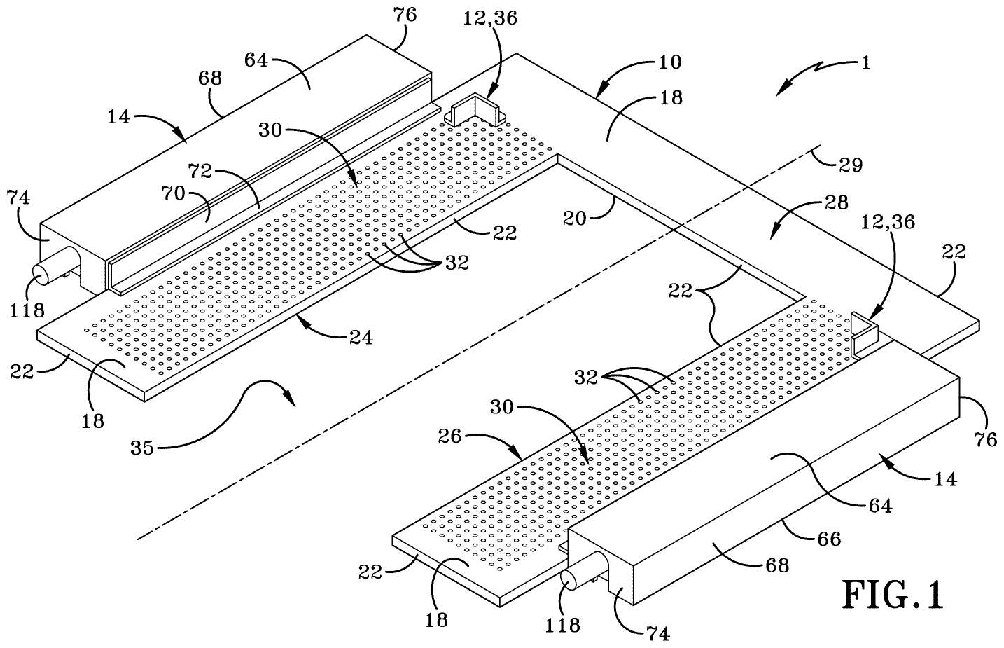

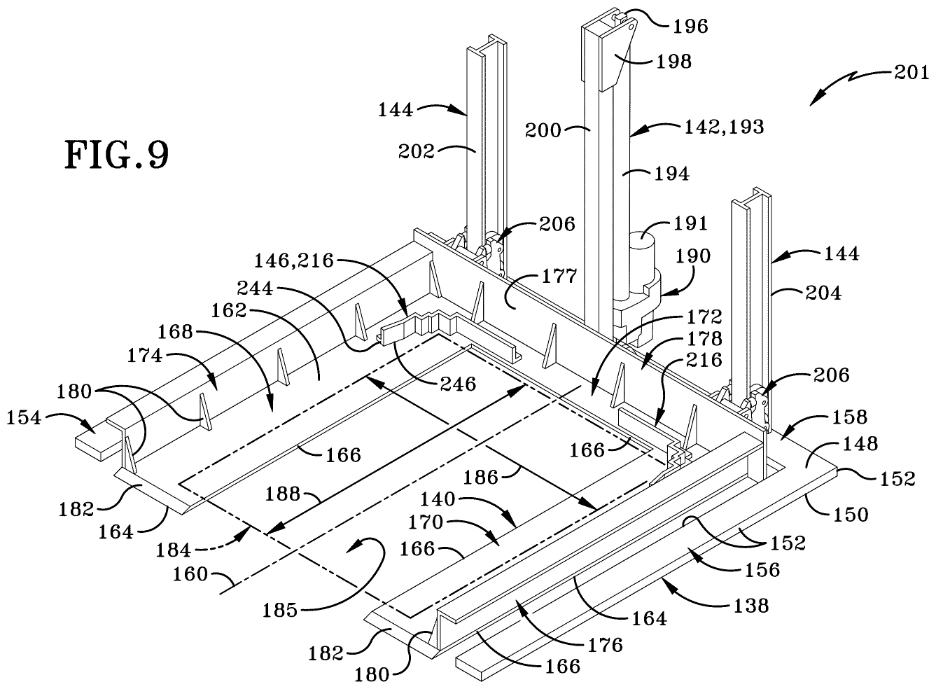

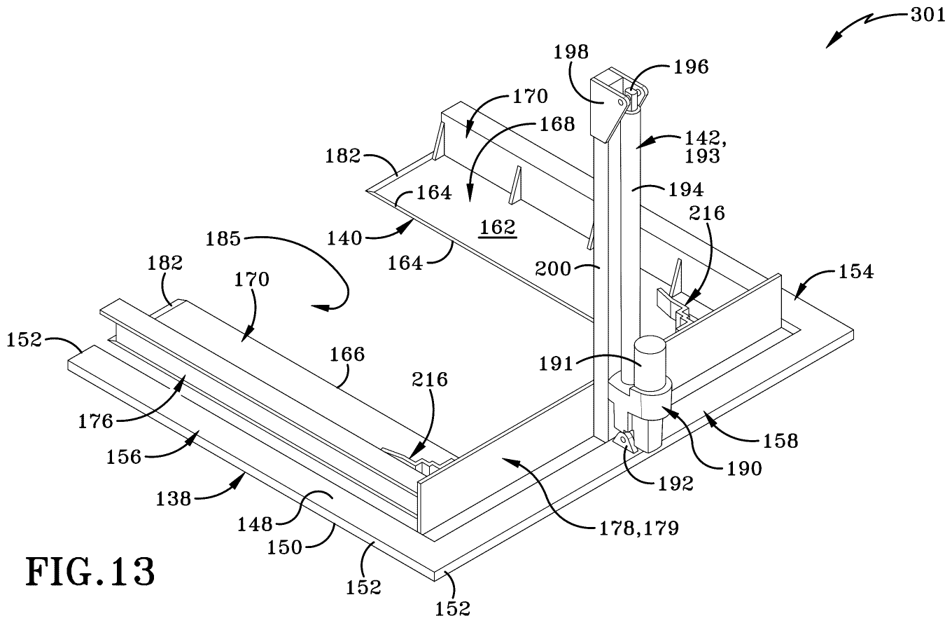

A pallet lifting assembly of the present disclosure depicted throughout FIGS. 1-13. A first embodiment of a pallet lifting assembly is shown in FIGS. 1-8G as pallet lifting assembly 1. A second embodiment of a pallet lifting assembly is shown in FIGS. 9-12 as pallet lifting assembly 201. A third embodiment of a pallet lifting assembly is shown in FIG. 13 as pallet lifting assembly 301. Each embodiment of the pallet lifting assembly may raise and lower pallets onto Autonomous Mobile Robots (AMRs) and/or Automated Guided Vehicles (AGV's). The AMR and/or AGV are a form of logistic carts used to transport heavy materials through large buildings. In order for an AMR and/or and AGV to receive a pallet, the pallet must be loaded onto a device that creates enough clearance for the AMR and/or AGV to drive under the pallet station. Most industrial warehouses are only equipped with pallet jacks that do not raise the pallets to a height suitable for an AMR and/or AGV to drive under. The pallet lifting assembly 1, 201, or 301 allows for a pallet to be loaded onto pallet lifting assembly 1, 201, or 301 at the height of the floor and then the pallet lifting assembly 1, 201, or 301 may be raised to an adjustable height to receive an AMR and/or AGV to receive the pallet. The pallet lifting assembly 1, 201, or 301 further allows industrial warehouses with different sized pallets to use the same equipment to load an AMR and/or AGV. The pallet lifting assembly 1, 201, or 301 may accommodate a variety of shapes and sizes of pallets to allow industrial factories to continue using different sized pallets for different equipment instead of standardizing on one size.

FIGS. 1-8G depict a first embodiment of a pallet lifting assembly 1 that may include a U-shaped or pallet receiver 10, a pin system 12, a cover 14 and a lifting jack 16.

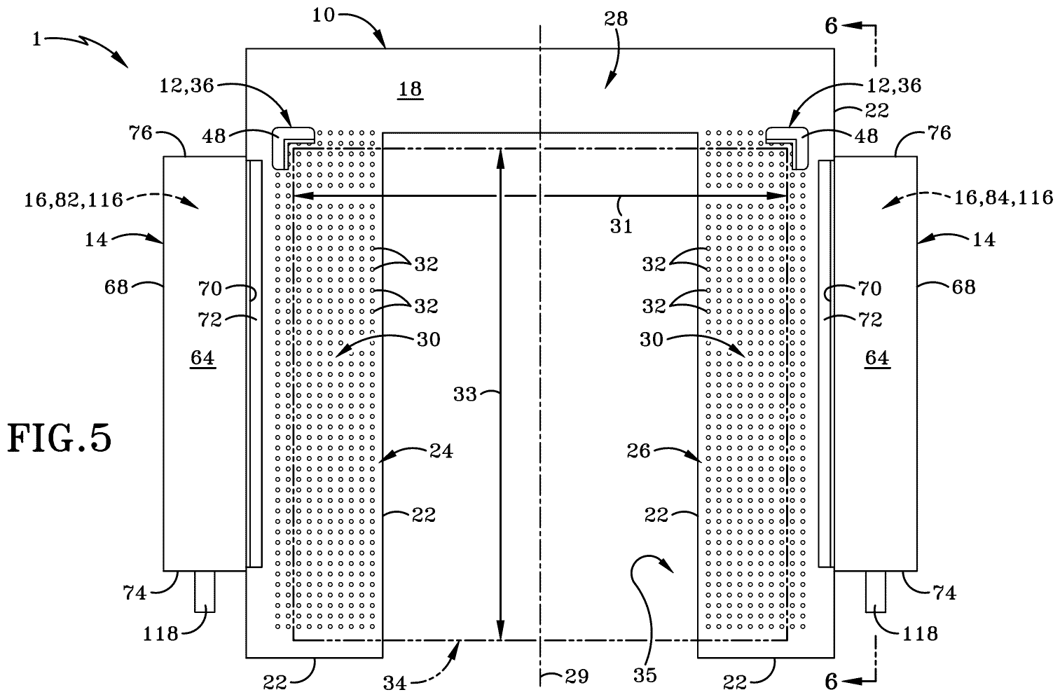

FIG. 1 depicts the pallet receiver 10 which may be formed generally as a U-shaped plate includes a top surface 18, and a bottom surface 20, and a peripheral wall 22 that is defined by the thickness of the plate extending between the top surface 18 and the bottom surface 20. It should be noted that pallet receiver 10 could have other configurations and the U-shape is exemplary. The U-shaped receiver 10 further includes a first leg 24 and a second leg 26 defining there between a lateral direction. First leg 24 and second leg 26 are parallel to each other and extend between their respective forward and rear ends. First leg 24 and second leg 26 are connected by a rear leg 28, wherein the first leg 24 and the second leg 26 create a mirror image of each other along a center axis 29 on the rear leg 28. A first embodiment of the U-shaped receiver 10 further includes a peg board surface 30 on both the first leg 24 and the second leg 26. The pegboard surface 30 may include one or more openings 32 adapted to receive attachment. The openings 32 extend from the top surface 18 on the first leg 24 and the second leg 26 toward the bottom surface 20 on the first leg 24 and the second leg 26. Openings 32 may extend fully through the legs 24,26 or only partially into legs 24,26. FIG. 5 depicts that the U-shaped receiver further includes a lifting region 34 wherein the lifting region 34 may include a portion of the first leg 24, the second leg 26, and the rear leg 28 that is configured to support an object on the first U-shaped receiver 10. The lifting region 34 is defined by arrow 31 to show the width of the lifting region and by arrow 33 to show the length of the lifting region 34. The U-shaped receiver 10 may further include an inner area 35 that is adapted to receive an AMR, wherein the inner area 35 is defined by the first leg 24, second leg 26, and rear leg 28.

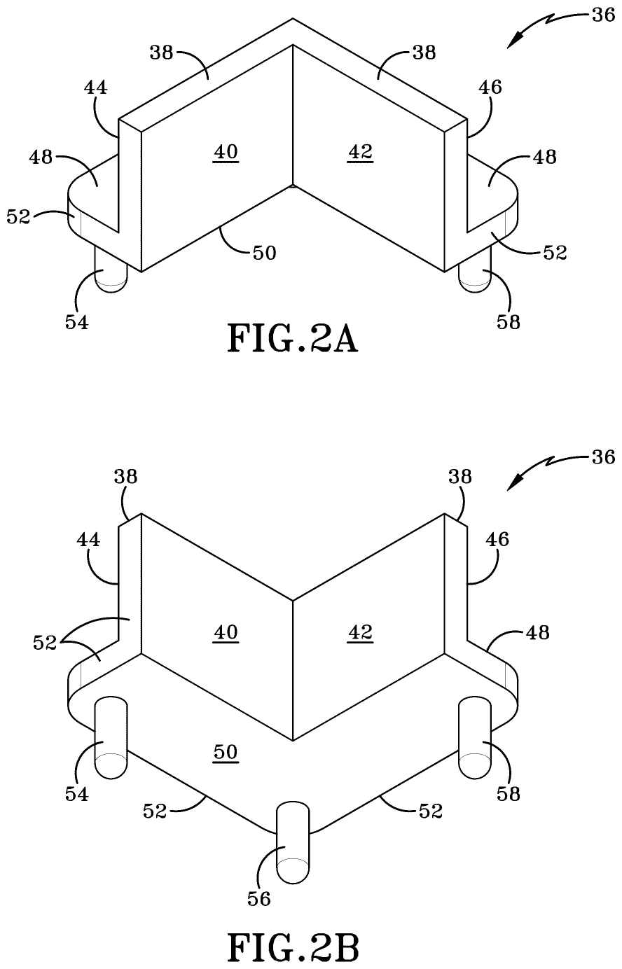

FIG. 2A and FIG. 2B depict the first embodiment in which the pin system 12 includes a set of corner braces 36 wherein the corner braces 36 are identical. The corner braces 36 include an upwardly facing top surface 38 that connects to a first interior wall section 40 and a second interior wall section 42. Wall section 40 and wall section 42 are orthogonal to each other. The top surface 38 also connects to a first exterior wall section 44 and a second exterior wall section 46. Wall section 44 and wall section 46 are orthogonal to each other. The first exterior wall section 44 and the second exterior wall section 46 connect to an upwardly facing top surface 48. The corner braces 36 further include a downwardly facing bottom surface 50 that is connected to the second top surface 48 by a peripheral wall section 52. The peripheral wall section 52 further connects the first top surface 38 to the bottom surface 50. The peripheral wall section 52 extends around the perimeter of the corner brace 36. The pin system further includes a first prong 54, a second prong 56 and a third prong 58 wherein the first prong 54 and the second prong 56 are a distance apart and the second prong 56 is equidistance from the third prong 58. First prong 54, second prong 56, and third prong 58 all extend downwardly from the bottom surface 50 of the corner brace 36. Stated otherwise, corner brace 36 has an L-shaped member defined by two orthogonal walls or legs. At the lower end of the L-shaped member is a flange that extends outward in a cantilever manner to form a widened base or lower end of the brace. The pins extend downward from the base.

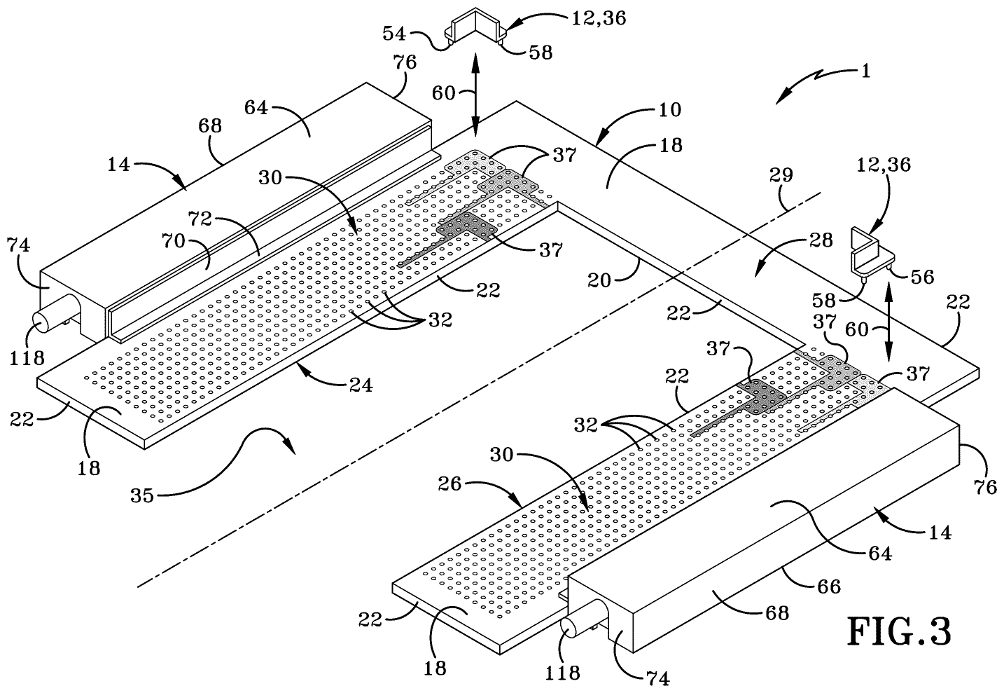

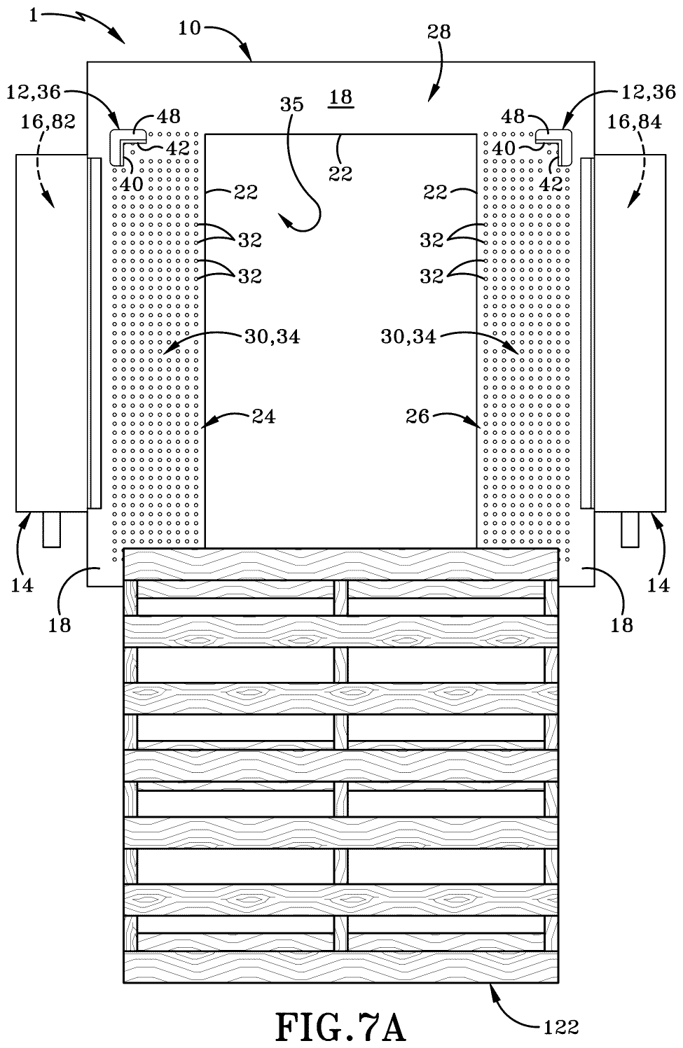

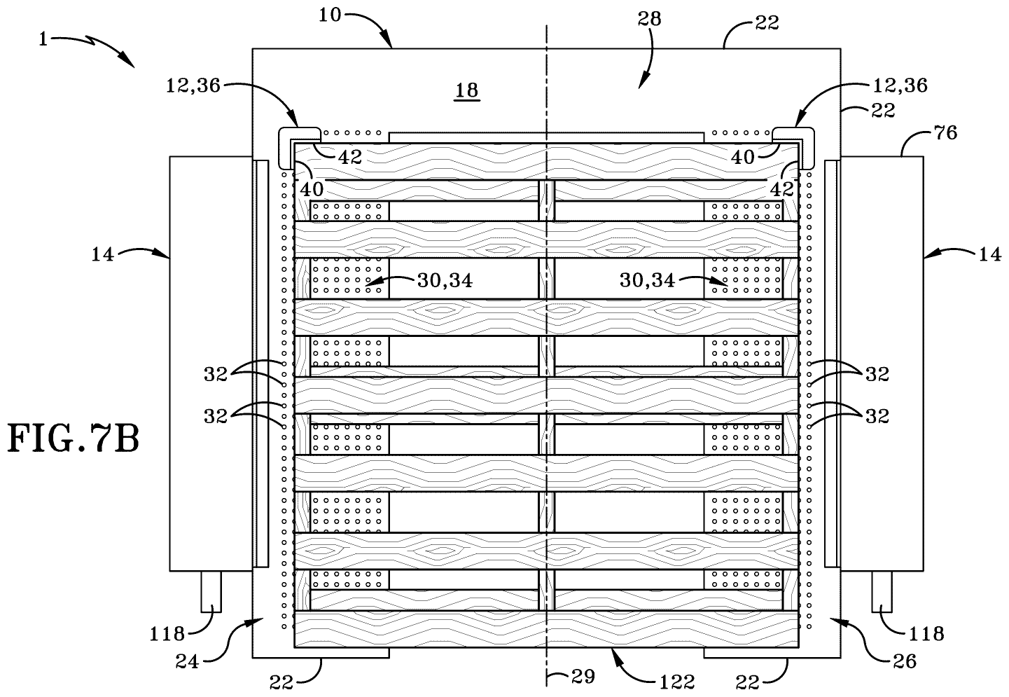

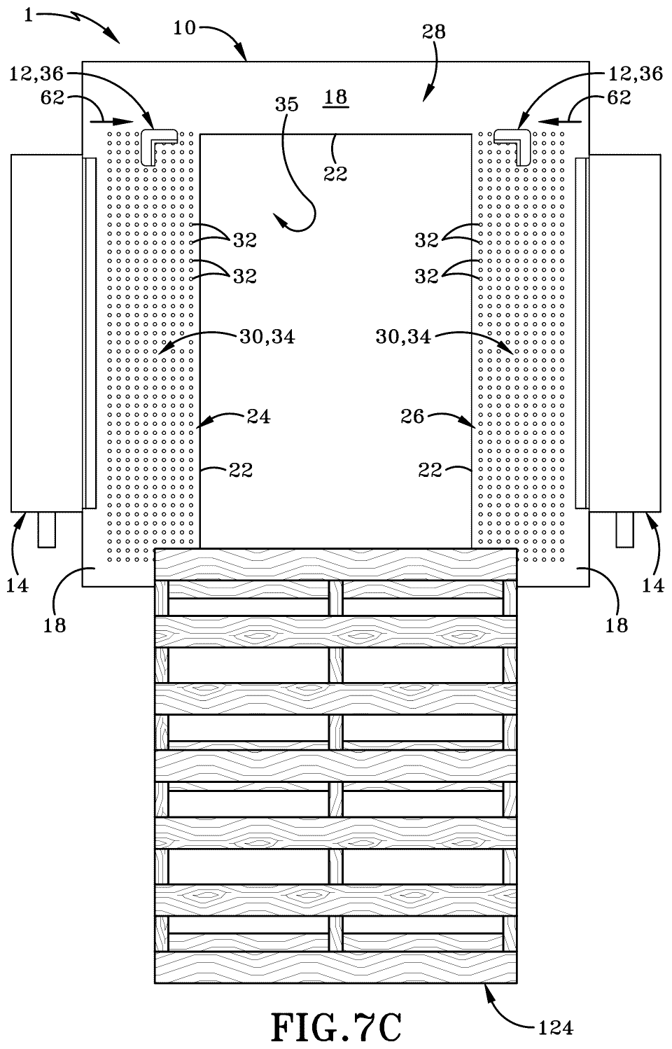

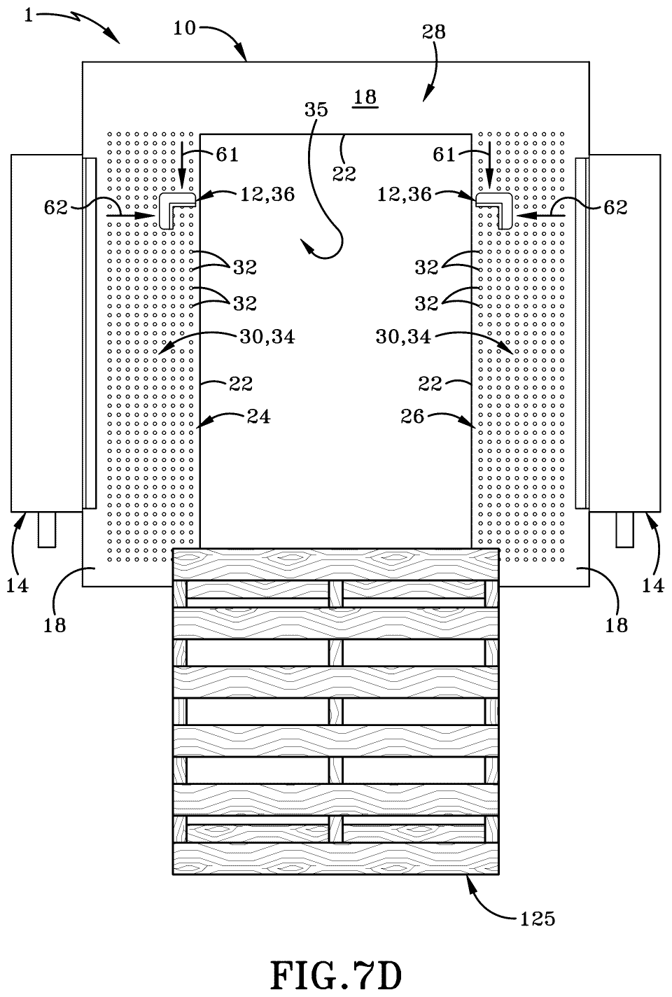

FIG. 3 depicts a first embodiment of U-shaped receiver 10 is adapted to connect with the first embodiment of pin system 12. The first embodiment of pin system 12 includes at least two corner braces 36 that are equipped at least two prongs. The shown embodiment is equipped with a first prong 54, a second prong 56 and a third prong 58 protruding from the bottom surface 50 of the corner brace 36. The first U-shaped receiver 10 includes openings 32 that collectively define a pegboard surface 30. The openings 32 receive at least two of the prongs. In one embodiment, the openings 32 are adapted to receive the first prong 54, second prong 56, and third prong 58 so that the corner brace 36 is connected to the U-shaped receiver 10. The corner brace 36 may move in a vertical direction to be inserted and removed from the U-shaped receiver 10 as indicated by double arrows 60 in FIG. 3. The corner braces 36 may also move along a horizontal plane to be inserted in a different location to receive different sized pallets as indicated by arrows 62 in FIG. 7A, FIG. 7C, and FIG. 7D. When the corner braces 36 are moved they define the lifting region 34 by arrow 31 defining the width which extends from one first interior wall 40 of a corner brace 36 to a second first interior wall section 40 of the opposite corner brace 36. The length of the lifting region 34 is defined by the arrow 33 which extends from each second interior wall section 42 of each of the corner braces 36 to the peripheral wall 22 of the U-shaped receiver 10. FIG. 3 further depicts a pallet footprint indicia 37 on the peg board surface 30 that may show where common sizes of pallets may rest in the lifting region 34. The pallet footprint indicia 37 may further act as a guide to show where to align the pallet to engage with the pin system 12 properly.

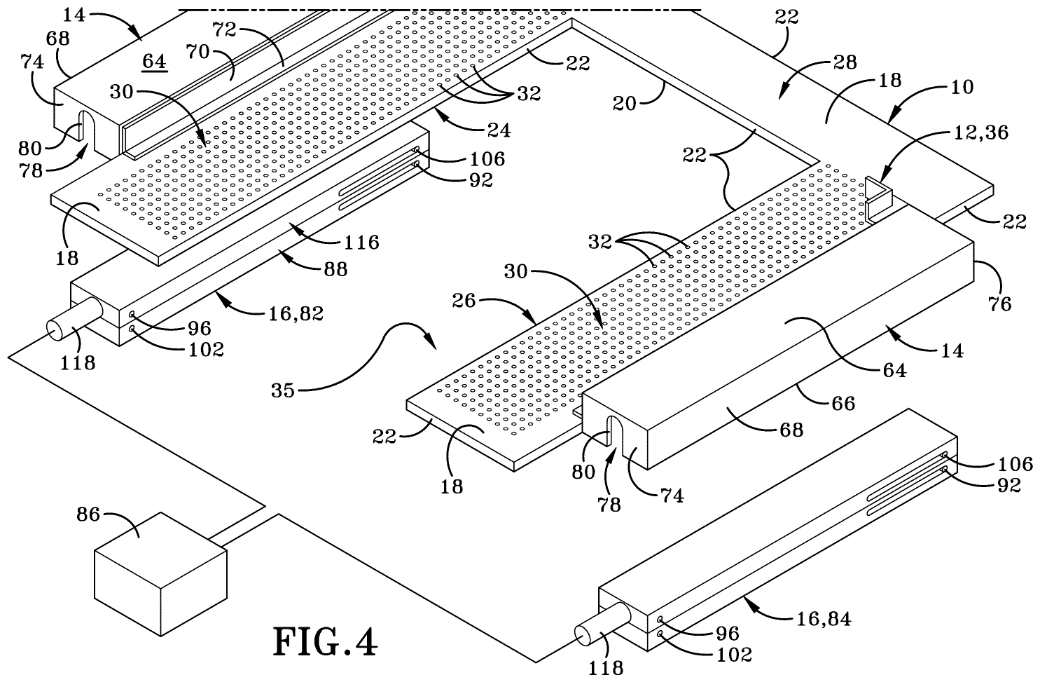

FIG. 4 depicts that the first embodiment of the pallet lifting assembly 1 includes at least one lift cover 14. The at least one lift cover 14 includes a top surface 64 and a bottom surface 66 wherein the at least one lift cover 14 is an elongated inverted U-shape defining a space below to receive a jack. Cover 14 further includes an exterior wall 68, and interior wall 70 that are spaced apart parallel to one another. The interior wall 70 further includes a ledge 72 that extends outwardly from the interior wall 70. Set of covers 14 further include a front wall 74 and a back wall 76. The front wall 74 further includes a cut out 78 defined by a peripheral wall 80. Cutout 78 extends upwardly from the lower edge of the front wall 74 defining a slot.

The U-shaped receiver 10 and the at least one lift cover 14 are attached. The ledge 72 of the covers 14 is attached to each side of the U-shaped receiver 10. The ledge 72 of the set of covers 14 is attached to the top surface 18 of the first leg 24 and the top surface 18 of the second leg 26. In one embodiment the ledge 72 may be attached to the U-shaped receiver 10 by welding. In another embodiment the ledge 72 may be attached to the U-shaped receiver 10 by riveting or screws. In yet another embodiment the ledge 72 may be attached to the U-shaped receiver 10 by an adhesive. In another embodiment the ledge 72 may be attached to the U-shaped receiver 10 in any other fashion suitable to secure the ledge 72 to the top surface 18 of the first leg 24 and the top surface 18 of the second leg 26.

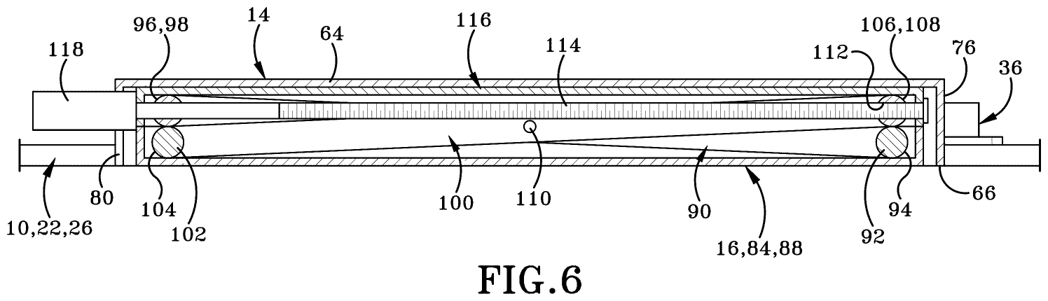

FIG. 4 and FIG. 6 depict that the pallet lifting assembly 1 includes a lifting jack 16. In one embodiment of the pallet lifting assembly 1, there is a first lifting jack 82 and a second lifting jack 84, wherein both the first lifting jack 82 and the second lifting jack 84 are the same but disposed on opposite sides of the U-shaped receiver 10. The first lifting jack 82 and the second lifting jack 84 are in operative communication with a control box 86 to ensure that both jacks move in tandem. In another exemplary embodiment the first lifting jack 82 and the second jack 84 may be mechanically connected to ensure they raise and lower in tandem. As best seen in FIG. 6, both the first lifting jack 82 and the second lifting jack 84 include a base 88, a first scissor leg 90 where the first scissor leg 90 has a first pin 92 on a first end 94 of the first scissor leg 90 and a second pin 96 on a second end 98 of the first scissor leg 90. The second pin 96 is in a fixed position. A second scissor leg 100 further includes a third pin 102 on a first end 104 of the second scissor leg 100 and a fourth pin 106 on a second end 108 of the second scissor leg 100. The third pin 102 is in a fixed position. The first scissor leg 90 and the second scissor leg 100 are connected at an axle pin 110 that goes through both the first scissor leg 90 at the center and the second scissor leg 100 at the center. The second scissor leg 100 may further include a threaded aperture 112 that is attached to the fourth pin 106. The first lifting jack 82 and the second lifting jack 84 includes a threaded cylinder 114. The fourth pin 106 and the threaded aperture 112 may move about the threaded cylinder 114. The lifting jack 16 may further include at least one housing unit 116 that contains all the jack components listed herein. A motor 118 is attached to the threaded cylinder 114 that extends outside of the housing unit 116. The first lifting jack 82 and the second lifting jack 84 each have their own housing units 116 to retain the parts listed herein.

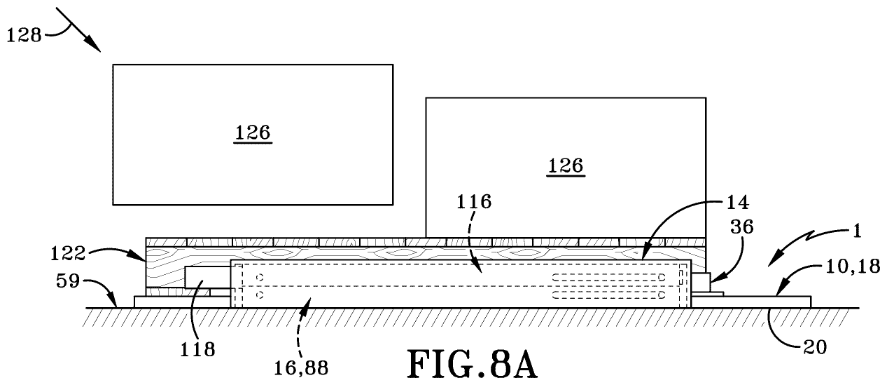

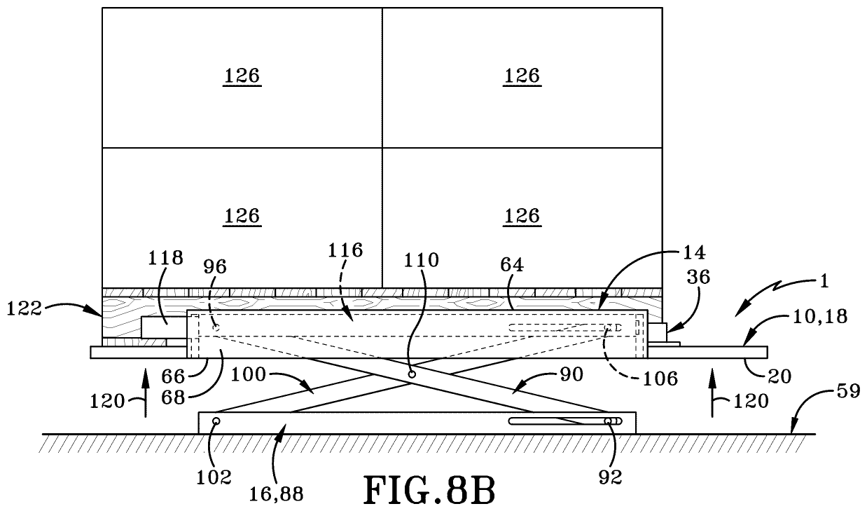

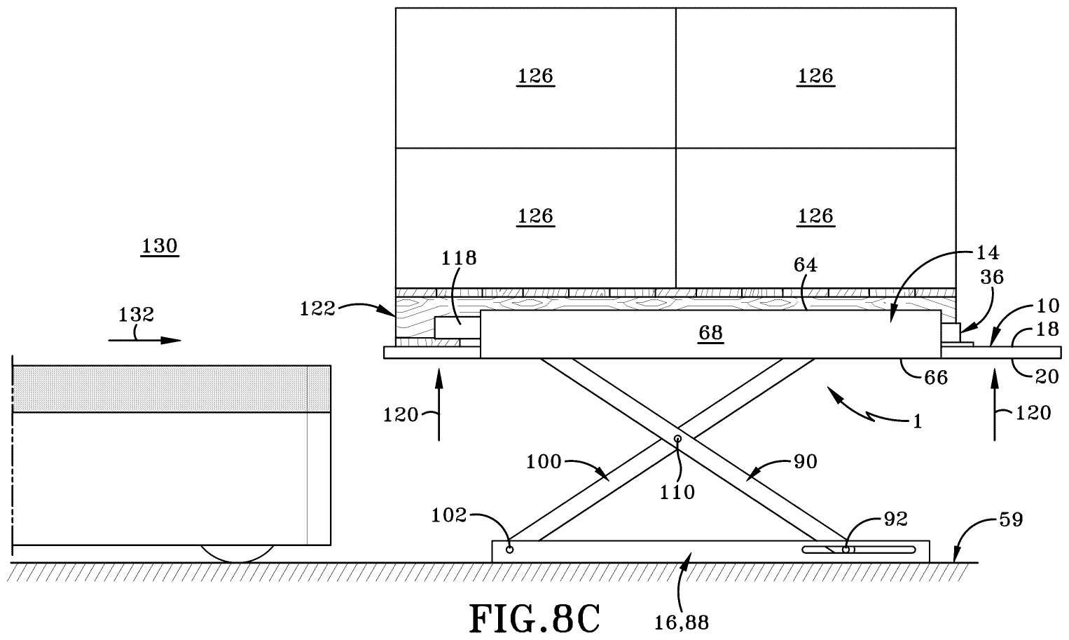

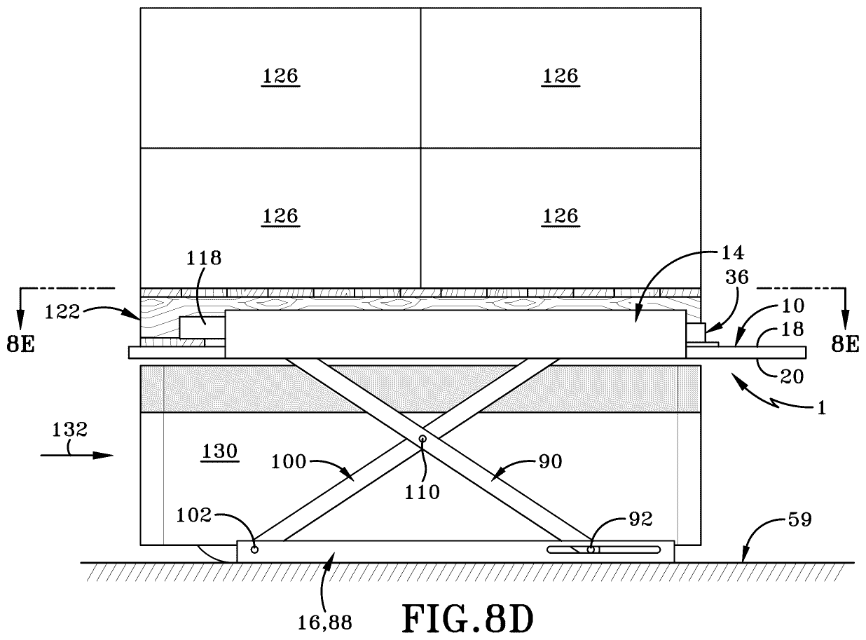

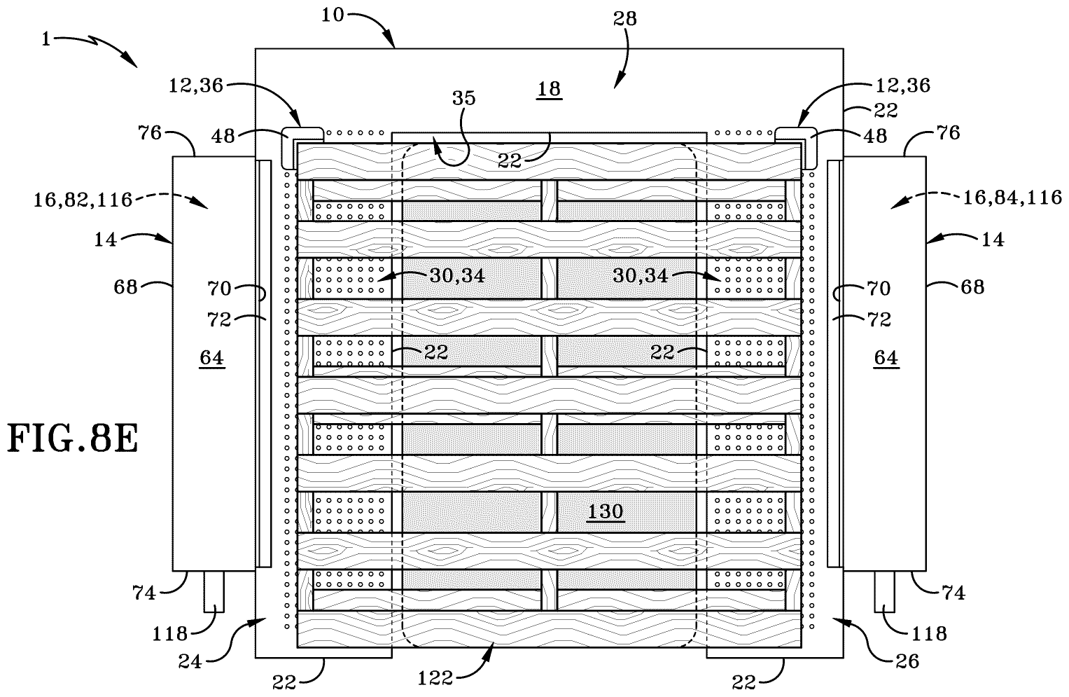

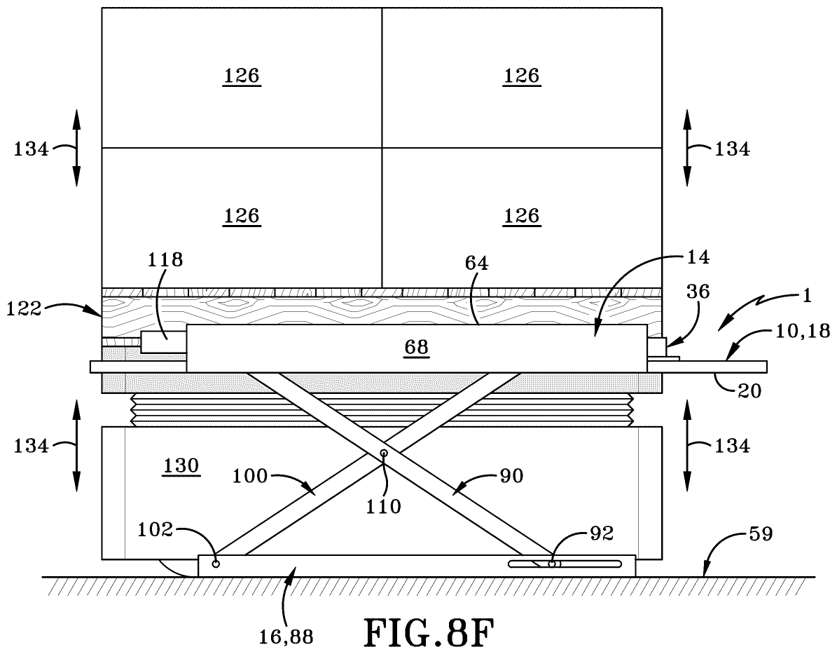

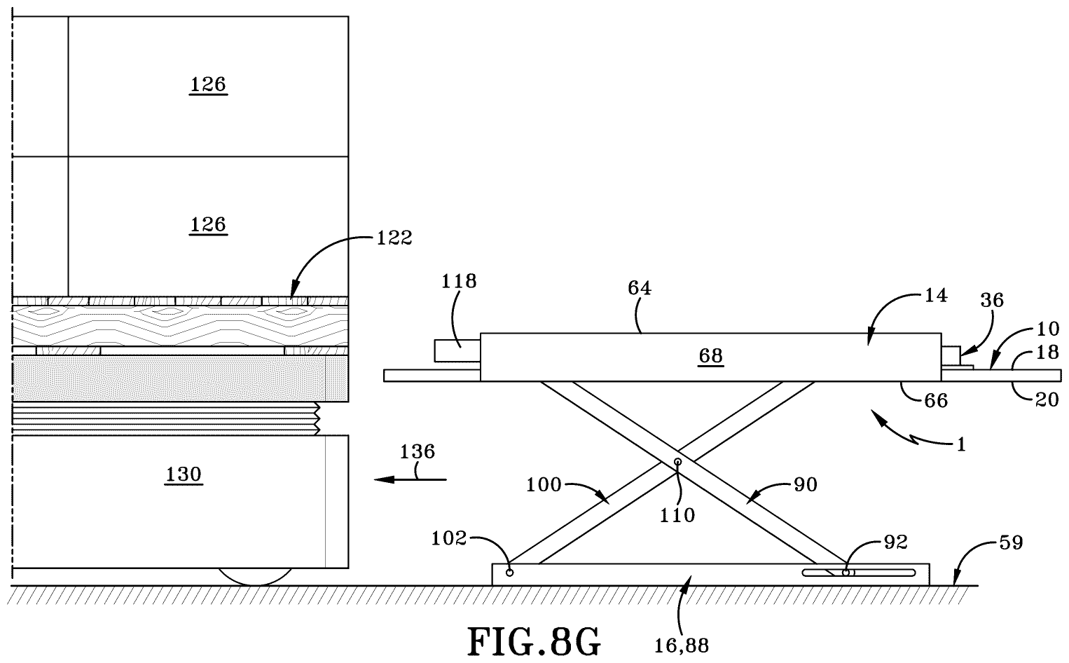

FIG. 1 depicts that the housing unit 116 rests inside of the cover 14 wherein the motor 118 of the lifting jack 16 fits into the cut out 78 of the cover 14. FIG. 8B and FIG. 8C show the housing unit 116 being raised by arrows 120. The first lifting jack 82 and the second lifting jack 84 are in operative communication with the U-shaped receiver 10 through the set of covers 14. The covers 14 allow the first lifting jack 82 and the second lifting jack 84 to raise the pallet lifting assembly 1 as shown by arrows 120 in FIG. 8B and FIG. 8C. Further, it should be understood that the pallet lifting assembly 1 may lower itself as shown in FIG. 8F.

As best seen in FIGS. 7A-7D, the pallet lifting assembly 1 may work with a first pallet 122, a second pallet 124, or a third pallet 125 that may be placed on the U-shaped receiver 10. The first pallet 122, the second pallet 124, and the third pallet 125 may be any size and shape. The first pallet 122, second pallet 124, and third pallet 125 are three of many exemplary embodiments of what pallets may be placed on the U-shaped receiver 10. The first pallet 122, the second pallet 124, or the third pallet 125 will rest on the lifting region 34 as defined by arrow 31 showing the width and arrow 33 showing the length on the U-shaped receiver 10. The first pallet 122 may abut the corner braces 36 of the pin system 12 as shown in FIG. 7B. The second pallet 124 may contact the corner braces 36 of the pin system 12 as shown in FIG. 7D by the movement arrows 61 and 62.

As best seen in FIG. 8A, the pallet lifting assembly also may include items 126. The items 126 may be placed on the first pallet 122 or the second pallet 124 as shown by the arrow 128. In one example, the items are boxes, but the items may be any object capable of being placed on a pallet.

As best seen in FIG. 8C, the pallet lifting assembly 1 may work with an Autonomous Mobile Robot (AMR)/Automated Guide Vehicle (AGV) 130. The AMR/AGV 130 is a self-driving vehicle that may drive below the pallet lifting assembly 1 as shown by arrow 132. Then the AMR/AGV 130 may carry the items 126 that is on the first pallet 122 or the second pallet 124 away as shown by arrow 136 (shown in FIG. 8G) and drop it off at a desired location.

Having now described the components and parts of the first embodiment of the pallet lifting assembly 1, methods of lifting pallets with the pallet lifting assembly 1 are discussed in greater detail below.

An operator may find space within their workstation whether it is a warehouse or another area. Once the customer has established a space that is clear of other items, the customer may install the pallet lifting assembly 1 to the floor 59. When the pallet lifting assembly 1 is placed on the floor 59, the U-shaped receiver 10 will almost be level with the floor 59. The thickness of the U-shaped receiver 10, defined by the peripheral wall 22, is sufficiently low so that a pallet jack can deliver a pallet to the pallet lifting assembly 1. The base 88 of the first lifting jack 82 and the base 88 of the second lifting jack 84 rest directly on the floor 59. The base 88 may be secured to the floor 59 to provide more stability for the pallet lifting assembly. Further, when the pallet lifting assembly 1 is in its fully lowered position the bottom surface 20 of the U-shaped receiver 10 will rest on the floor 59.

The manufacturer may take the steps herein to prepare the pallet lifting assembly 1 for the operator. The set of covers 14 may be attached to the U-shaped receiver 10. Covers 14 may be attached to the U-shaped receiver 10 by attaching the ledge 72 of the cover 14 to the top surface 18 of the first leg 24 and of the second leg 26 of the U-shaped receiver 10. Once the covers 14 are attached, the covers 14 will create a mirror image of one another along the center line 29 of the U-shaped receiver 10. Further, the covers 14 will extend over the edge of the U-shaped receiver 10 so that a lifting mechanism may be inserted without being under the U-shaped receiver 10. The covers 14 will then each receive a lifting jack from the set of lifting jacks 16. The lifting jacks 16 each have a housing unit 116 that rests inside of the covers 14. Motor 118 will extend outside of the covers 14 and rest inside of the cut outs 78 of each cover 14.

The operator may assemble the pallet lifting assembly 1 by inserting the first prong 54, the second prong 56, and the third prong 58 of the corner braces 36 of the pin system 12 into the U-shaped receiver 10. The corner braces 36 are inserted through the openings 32 of the peg board surface 30 on both the first leg 24 and through the openings 32 of the peg board surface 30 on the second leg 26. At this stage of assembly, the U-shaped receiver 10 and pin system 12 are engaged with one another.

Next, the U-shaped receiver 10 is at floor level with the set of covers 14 on each of the first leg 24 and the second leg 26. Inside each of the covers 14 there is a first lifting jack 82 or a second lifting jack 84 in their own covers 14. The pin system 12 may be moved to ensure that the corner braces 36 are in line to support the size of the pallet that the operator may use. The corner braces 36 may be moved longitudinally as shown by arrows 61. The corner braces 36 may also be moved laterally as shown by arrows 62 to achieve a desired fit for any shape of a pallet. In another exemplary embodiment, there may be additional corner braces 36 that may be placed in the peg board 30 of the U-shaped receiver 10 to support various shapes and sizes of pallets. At this stage in assembly, the logistics operator may begin to use the pallet lifting assembly 1.

Next, an operator may load items 126 on a first pallet 122 as shown by arrow 128 in FIG. 8A. As best shown in FIG. 7A and FIG. 7B, once the operator has achieved a desired fit for the first pallet 122 by relocating the corner braces 36 of the pin system 12 then the operator may use a pallet jack to lift the first pallet 122 and place it onto the lifting region 34 of the U-shaped receiver 10. The lifting region is defined by arrow 31 showing the width of the lifting region 34 and arrow 33 showing the length of lifting region 34. Once the first pallet 122 is placed on the top surface 18 of the U-shaped receiver 10 within the lifting region 34 then the operator may begin to raise the pallet lifting assembly 1. To raise pallet lifting assembly 1 an operator will turn on motor 118 of the lifting jacks 16. The control box 86 will allow both the first lifting jack 82 and the second lifting jack 84 to move in tandem. Once the motor 118 and the control box 86 are initiated, the threaded cylinder 114 will begin to rotate. When the threaded cylinder 114 begins to rotate the threaded aperture 112 that is attached to the fourth pin 106 begins to move along the threaded cylinder 114. The second pin 96 and the third pin 102 remain stationary as the threaded aperture 112 and the fourth pin 106 move along the threaded cylinder 114. As the fourth pin 106 begins to move along the threaded cylinder 114 it will cause the first pin 92 to move along the base 88 so that the lifting jacks 16 may rise. The first scissor leg 90 and the second scissor leg 100 move about the axle pin 110 to allow the lifting jack 16 to rise when the first pin 92 and the fourth pin 106 move towards the second pin 96 and the third pin 102 respectively (shown in FIG. 8B and FIG. 8C). The first scissor leg 90 and the second scissor leg 100 may move from a generally horizontal position to a generally raised position to raise the pallet lifting assembly 1.

Following the lifting or raising of the pallet lifting assembly 1, the AMR 130 may drive under the pallet lifting assembly 1 as shown by arrow 132 in FIG. 8C and FIG. 8D. Once the AMR 130 is under the pallet lifting assembly 1, the AMR 130 will be centered in the inner area 35 of the pallet 122 that is not supported by the lifting region 34 of the U-shaped receiver 10 (shown in FIG. 8E). The AMR 130 may then receive the pallet 122 by the pallet lifting assembly 1 lowering the pallet 122 onto the AMR 130 or by the AMR 130 raising itself to the pallet 122 as indicated by the double arrows 134 in FIG. 8F. The pallet lifting assembly 1 may include sensors to detect that the AMR 130 is underneath and then the pallet lifting assembly 1 may then lower itself automatically. Once the AMR 130 is loaded with the first pallet 122 the AMR may drive away as shown by arrow 136 in FIG. 8G and take the first pallet 122 with the cargo 126 to the desired location by the operator.

The motor 118 of the lifting jack 116 may rotate the threaded cylinder 114 in the opposite direction to rotate the threaded aperture 112 that is attached to the fourth pin 106 begins to move along the threaded cylinder 114 in the opposite direction. The second pin 96 and the third pin 102 remain stationary as the threaded aperture 112 and the fourth pin 106 move along the threaded cylinder 114. As the fourth pin 106 begins to move along the threaded cylinder 114 in the opposite direction it will cause the first pin 92 to move along the base 88 so that the lifting jacks 16 may lower. The first scissor leg 90 and the second scissor leg 100 move about the axle pin 110 to allow the lifting jack 16 to lower when the first pin 92 and the fourth pin 106 move away from the second pin 96 and the third pin 102 respectively. The first scissor leg 90 and the second scissor leg 100 may move from a generally raised position to a generally horizontal position to lower the pallet lifting assembly 1.

In another exemplary embodiment of the present disclosure pin system 12 may include additional corner braces 36 to support different sized pallets. In one exemplary embodiment the pin system 12 may include four corner braces 36 to support a pallet that is not traditional size. In another embodiment the corner braces may not form a 90 degree angle and may then support non-traditionally shaped items.

FIGS. 9-12 depict a second embodiment of a pallet lifting assembly 201 that may include a U-shaped base 138, a U-shaped plate 140, a lifting mechanism 142, a trolley system 144, and a guide system 146.

FIG. 9 depicts that the second embodiment of the pallet lifting assembly 201 includes the U-shaped base 138 which includes a top surface 148, and a bottom surface 150, and a peripheral wall 152 that is defined by the thickness of the U-shaped base 138 extending between the top surface 148 and the bottom surface 150. The U-shaped base 138 further includes a first leg 154 and a second leg 156 defining there between a lateral direction. First leg 154 and second leg 156 are parallel to each other and extend between their respective forward and rear ends. First leg 154 and second leg 156 are connected by a rear leg 158, wherein the first leg 154 and the second leg 156 create a mirror image of each other along a center axis 160 on the rear leg 158. The bottom surface 150 of U-shaped base 138 rests directly on the floor 59 and in another embodiment may be secured to the floor 59.

FIG. 9 further depicts that the second embodiment of the pallet lifting assembly 201 includes the U-shaped plate 140. The U-shaped plate 140 includes a top surface 162, and a bottom surface 164, and a peripheral wall 166 that is defined by the thickness of the U-shaped plate 140 extending between the top surface 162 and the bottom surface 164. The U-shaped plate 140 further includes a first leg 168 and a second leg 170 defining there between a lateral direction. First leg 168 and second leg 170 are connected by a rear leg 172, wherein the first leg 168 and the second leg 170 create a mirror image of each other along the center axis 160 on the rear leg 172. U-shaped plate 140 further includes a first wall section 174 that extends from the first leg 168, a second wall section 176 that extends from the second leg 170, wherein the first wall section 174 and the second wall section 176 are each downwardly facing or inverted L-shaped wall sections. Stated otherwise, the upper end of the L-shaped wall is a flange that extends outward in a cantilever manner to form a widened top surface on the first wall section 174 and second wall section 176. U-shaped plate 140 includes a rear wall section 178 that extends from the rear leg 172 wherein the rear wall section 178 is an upwardly facing L-shaped wall section which has an interior surface 177 and an exterior surface 179. Stated otherwise, at the lower end of the L-shaped wall section there is a flange that extends outward in a cantilever manner to form a widened lower end of the rear wall section 178. The U-shaped plate 140 includes at least one gusset 180 that may secure the first wall section 174 and/or the second wall section 176 and/or the rear wall section 178 to the top surface 162 of the U-shaped plate 140. At the forward end of the first leg 168 and the second leg 170 there is a sloped surface 182. A lifting region 184 is defined by an arrow 186 which depicts the width of the lifting region 184 and an arrow 188 which depicts the length of the lifting region 184. The U-shaped plate 140 may further include an inner area 185 that is adapted to receive an AMR, wherein the inner area 185 is defined by the first leg 168, second leg 170 and rear leg 172.

FIG. 9 depicts that the U-shaped base 138 and U-shaped plate 140 are configured to work in conjunction with one another. U-shaped base 138 may be mounted on the floor 59 or rest on the floor 59. When U-shaped plate 140 is in its lowered position the U-shaped plate 140 rests inside of the U-shaped base 138. The U-shaped base 138 remains stationary while the U-shaped plate 140 may move to a raised and lowered position.

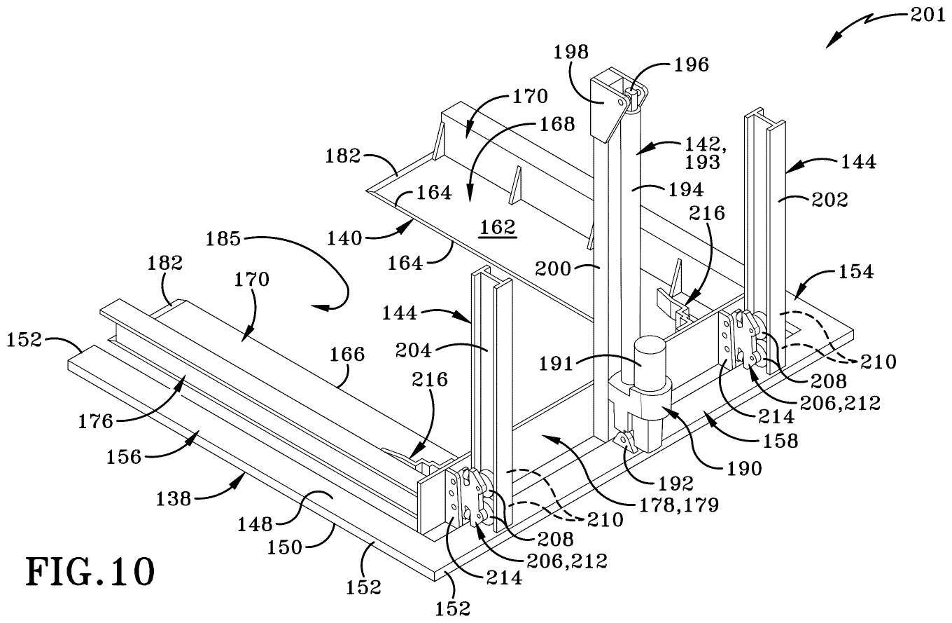

FIG. 10 depicts that the second embodiment of pallet lifting assembly 201 includes the lifting mechanism 142, wherein the lifting mechanism 142 includes a main body 190 and a mount 192 wherein the mount 192 is connected to the main body 190. The lifting mechanism 142 further includes an actuator 193 composed of a cylinder 194 and an extension rod 196 wherein the extension rod 196 is inside of the cylinder 194 when the pallet lifting assembly 201 is at its lowered position. The extension rod 196 may extend out of the cylinder 194 when the pallet lifting assembly 201 is in a raised position. The lifting mechanism 142 further includes a connector 198 and a beam 200 wherein the connector 198 secures the extension rod 196 to the beam 200 so that the beam 200 and the extension rod 196 move in tandem. In the second embodiment of the pallet lifting assembly 201 a motor 191 of the main body 190 may rotate the extension rod 196 therefore causing the extension rod 196 and the beam 200 to rise. The motor 191 of main body 190 may also reverse the rotation of the extension rod 196 therefore allowing the extension rod 196 and the beam 200 to be lowered. Alternatively, a hydraulic actuator may be used, or the actuator may be an electric actuator.

FIG. 10 depicts the lifting mechanism 142 that is attached to the U-shaped base 138 and the U-shaped plate 140. The lifting mechanism 142 is attached to the U-shaped base 138 with the mount 192 mounted on the top surface 148 of the rear leg 158 of the U-shaped base 138. The lifting mechanism 142 is attached to the U-shaped plate 140 by the connector 198 secured to the beam 200 which is secured to the exterior surface 179 of the rear wall section 178 of the U-shaped plate 140.

FIG. 10 further depicts that the second embodiment of the pallet lifting assembly 201 includes the trolley system 144, wherein the trolley system 144 includes a first I-beam 202 and a second I-beam 204 wherein the first I-beam 202 and the second I-beam 204 are identical and have similar parts referenced herein. Each I-beam acts as a track for a trolley 206. Trolley 206 has a first pair of wheels 208, a second pair of wheels 210, a frame 212, and a fastener 214. The first pair of wheels 208 and the second pair of wheels 210 are connected by frame 212 to ensure the wheels move in tandem. The first pair of wheels 208 and the second pair of wheels 210 remain on opposite sides of the I-beam 202 or 204. The fastener 214 is secured to frame 212 on each of the first I-beam 202 and the second I-beam 204. The first pair of wheels 208 and the second pair of wheels 210 are engaged with the I-beam 202 or 204 and may glide along the surface of the I-beam 202 or 204 in tandem.

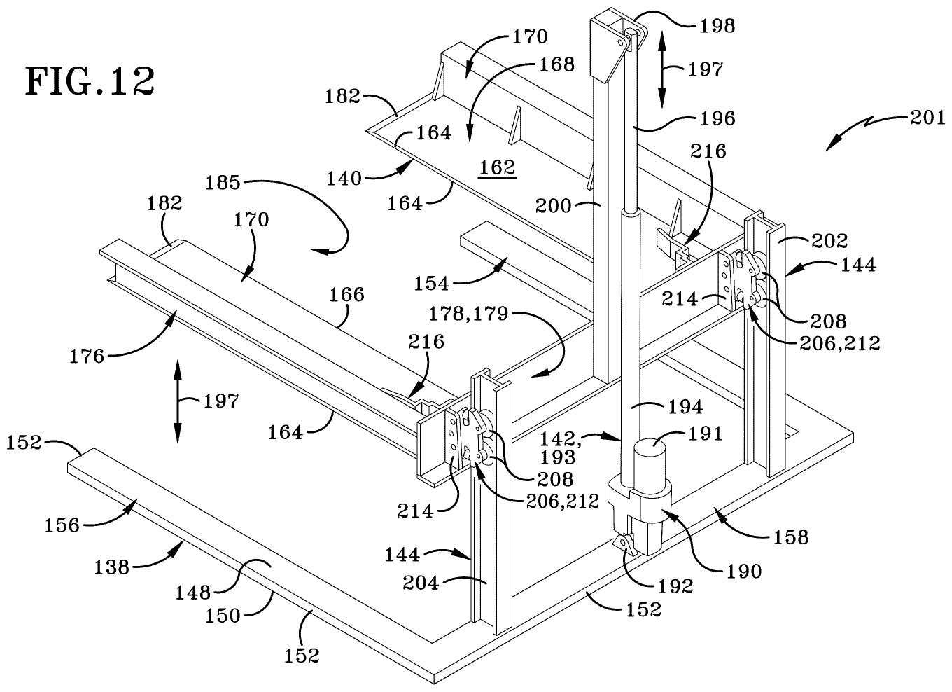

FIG. 10 depicts the trolley system 144 attached to the U-shaped base 138 and U-shaped plate 140. Both the first I-beam 202 and second I-beam 204 are attached to the top surface 148 of the U-shaped base 138. The fastener 214 is attached to the exterior surface 179 of the L-shaped rear wall section 178 of the U-shaped plate 140. The I-beams 202 and 204 remain stationary on the U-shaped base 138 and the first pair of wheels 208 and second pair of wheels 210 on trolley 206 may glide along the surface of the I-beams 202 and 204 to raise and lower the U-shaped plate 140 as depicted by a double arrow 197 (shown in FIG. 12). Further, the first I-beam 202 and the second I-beam 204 are equidistance from the lifting mechanism 142 on the rear leg 158. Trolley system 144 may further provide radial and axial support to the pallet lifting assembly 201.

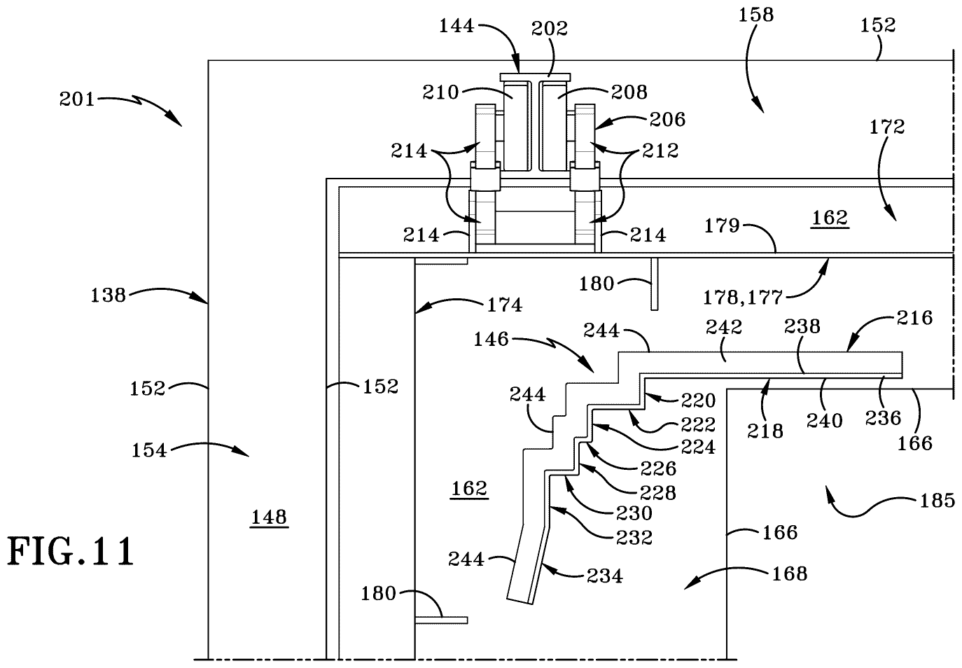

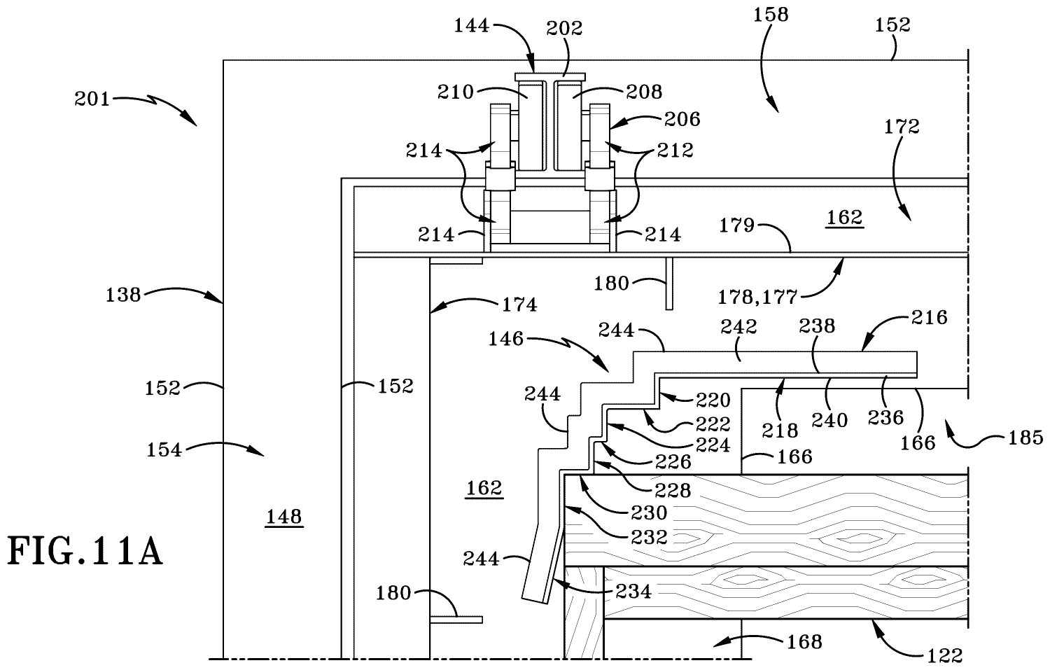

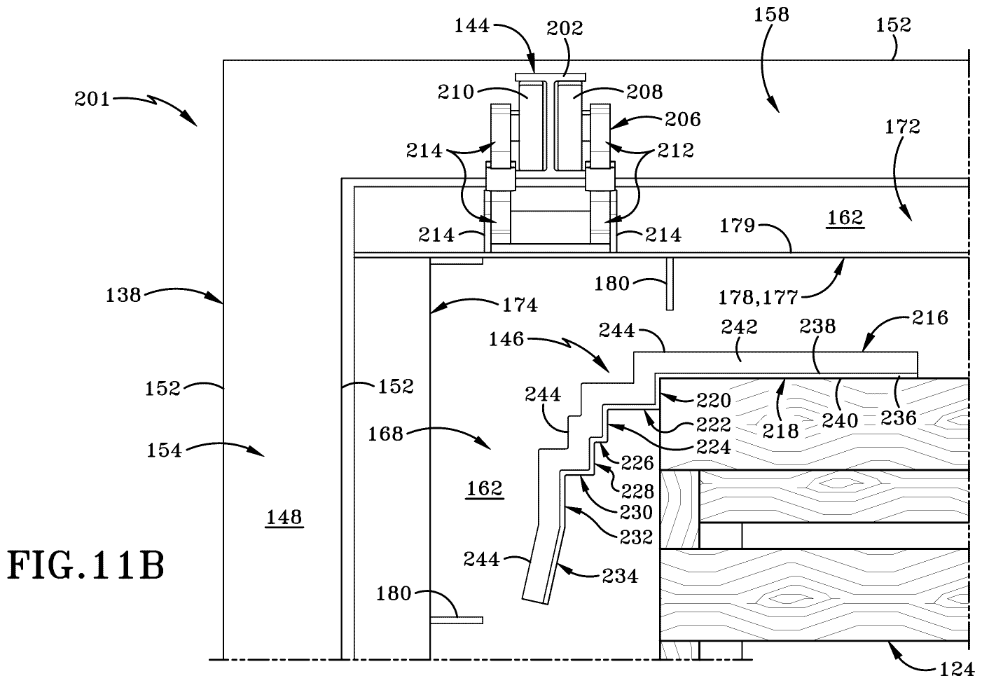

FIG. 11 depicts the guide system 146. Guide system 146 has at least one pallet retention device 216. Pallet retention device 216 operates as a poka-yoke device to ensure that a pallet is properly retained atop the U-shaped lifting plate 140. The at least one pallet retention device 216 has a first wall section 218 and a second wall section 220 that are orthogonal to one another wherein the first wall section 218 and the second wall section are different lengths. The at least one pallet retention device 216 has a third wall section 222 and a fourth wall section 224 wherein the third wall section 222 and the fourth wall section 224 are orthogonal to one another and wherein the third wall section 222 and the fourth wall section 224 are different lengths. The at least one pallet retention device 216 has a fifth wall section 226 and a sixth wall section 228 wherein the fifth wall section 226 and the sixth wall section 228 are orthogonal to one another and wherein the fifth wall section 226 and the sixth wall section are different lengths. The at least one pallet retention device 216 has a seventh wall section 230 and an eighth wall section 232 wherein the seventh wall section 230 and the eighth wall section 232 are orthogonal to one another and wherein the seventh wall section 230 and the eighth wall section 232 are different lengths. The at least one pallet retention device 216 has a ninth wall section 234 that is at an angle between 90 degrees and 180 degrees in relation to the eighth wall section 232. First wall section 218, third wall section 222, fifth wall section 226, and seventh wall section 230 are all parallel to one another and perpendicular to the second wall section 220, fourth wall section 224, sixth wall section 228, and eighth wall section 232 that are all parallel to one another. The at least one pallet retention device 216 further includes a first upwardly facing top surface 236 that connects to an exterior surface 238 and an interior surface 240. The at least one pallet retention device 216 includes a second upwardly facing top surface 242 that is orthogonal to the exterior surface 238. The at least one pallet retention device 216 includes a peripheral wall 244 that extends around the perimeter of the at least one pallet retention device 216 and connects to the bottom surface 246 of the at least one pallet retention device 216. The first upwardly facing top surface 236, exterior surface 238, interior surface 240, second upwardly facing top surface 242, peripheral wall 244, and bottom surface 246 collectively extend from the first wall section 218 through the ninth wall section 234.

FIG. 11 depicts the at least one pallet retention device 216 attached to the U-shaped plate 140. The bottom surface 246 of the at least one pallet retention device 216 is connected to the top surface 162 of the U-shaped plate 140. The at least one pallet retention device 216 may work with a first pallet 122 (shown in FIG. 11A) or work with a second pallet 124 (shown in FIG. 11B). In the present embodiment of pallet lifting assembly 201 two pallet retention devices 216 are shown and the pallet retention device 216 may work with any sized pallet that the pallet retention device 216 can support.

Having now described the components and parts of the second embodiment of the pallet lifting assembly 201, methods of lifting pallets with the pallet lifting assembly 201 are discussed in greater detail below.

An operator may find space within their workstation whether it is a warehouse or another area that is clear of other items, the customer may install the second embodiment of pallet lifting assembly 201 to the floor 59. When the pallet lifting assembly 201 is placed on the floor 59 the U-shaped base 138 will rest on the floor 59 and/or be secured to the floor 59 and remain stationary whether the pallet lifting assembly 201 is in the raised position or in its lowered position. Further, when the pallet lifting assembly 201 is in its lowered position the U-shaped plate 140 also rests on the floor 59. The thickness of U-shaped plate 140 is defined by the peripheral wall 166 which is sufficiently low so that a pallet jack can deliver a pallet to the pallet lifting assembly. In one exemplary embodiment the thickness of the U-shaped plate 140 may be ¼″. The U-shaped plate 140 further includes a sloped surface 182 on the front end of the first leg 168 and the second leg 170 which may allow even more ease to deliver a pallet to the pallet lifting assembly 201. The U-shaped plate 140 may be raised and lowered as the operator needs while the U-shaped base 138 remains on the floor 59 with the lifting mechanism 142 and the trolley system 144 attached thereto.

In operation, the operator may assemble the second embodiment of the pallet lifting assembly 201 by securing the U-shaped base 138 to the floor 59 to ensure it is stable and does not move during operation. Next, the operator may ensure that the U-shaped plate 140 is in the lowered position so that the bottom surface 164 is resting on the floor 59. The operator may then find a desired pallet 122 and the operator may use a pallet jack to lift the pallet 122 onto the lifting region 184 of the U-shaped plate 140. The pallet 122 may be sized by the operator using the guide system 146. When the operator uses the guide system 146, they may place the pallet 122 against at least one of the wall sections of at least one pallet retention device 216. In one exemplary embodiment the pallet 124 is resting against the first wall section 218 and the second wall section 220. In another exemplary embodiment the pallet 122 may rest against the seventh wall section 230 and the eighth wall section 232. In yet another exemplary embodiment a pallet of a different size may rest against the third wall section 222 and the fourth wall section 224. In yet another exemplary embodiment an additional pallet of a different size may rest against the fifth wall section 226 and the sixth wall section 228. In yet another exemplary embodiment a pallet of a non-traditional size/shape may rest against the ninth wall section 234. In another exemplary embodiment a pallet may rest against any combination of the wall sections on the pallet retention device 216.

Following the placement of the pallet 122 on the lifting region 184 of the second embodiment of the pallet lifting assembly 201 the operator may then begin to raise the pallet lifting assembly. To raise a portion of the pallet lifting assembly 201 the operator may initiate the motor 191. As the motor 191 rotates the extension rod 196 inside the cylinder 194 the extension rod 196 begins to move in a vertical direction. As the extension rod 196 moves in a vertical direction the trolley system 144 beings to move in tandem with the lifting mechanism 142. The first pair of wheels 208 and the second pair of wheels 210 may move in a vertical direction along the first I-beam 202 and the second I-beam 204. The operator may stop the lifting mechanism 142 when the pallet lifting assembly 201 has reached a desired height. Alternatively, a sensor can be used to automatically stop the lifting mechanism when the pallet reaches its desired height.

Once the operator has determined the pallet lifting assembly 201 is at the desired height, the AMR 130 may drive under the pallet lifting assembly 201 similar to what is shown in FIG. 8C and FIG. 8D in the first embodiment. Once the AMR 130 is under pallet lifting assembly 201, the AMR will be centered under the part of the pallet 122 that is not supported by the lifting region 184 of the U-shaped plate 140 similar to what is shown in FIG. 8E of the first embodiment. The AMR 130 may then receive the pallet 122 by the pallet lifting assembly 201 lowering the pallet 122 onto the AMR 130. The operator may lower the pallet lifting assembly 201 by reversing the direction of the motor 191 the causing the extension rod 196 to move in a downward direction allowing the AMR 130 to receive the pallet 122 from the U-shaped plate 140. The pallet lifting assembly 201 may also have a sensor that is able to detect when the AMR 130 is underneath the pallet lifting assembly 201 and automatically lower itself onto the AMR 130. The AMR 130 may be able to fit inside the perimeter of the U-shaped base 138 so that it may receive the pallet 122 without the lifting mechanism 142 or the trolley system 144 obstructing the transfer of the pallet 122 from the U-shaped plate 140 to the AMR 130. In another exemplary embodiment the AMR 130 may be capable of raising and lowering itself to receive pallet 122. Once the AMR 130 is loaded with the pallet 122 the AMR 130 may drive away similar to what is shown in FIG. 8G in the first embodiment. The AMR 130 may take the pallet 122 to the desired location of the operator.

Next, the operator may lower the pallet lifting assembly 201 to its lowered position by continuing to reverse the direction of the motor 191. As the motor 191 spins the extension rod 196 in the opposite direction the extension rod 196 will begin to retract into the cylinder 194 and this will allow the first pair of wheels 208 and the second pair of wheels 210 to move downwardly along the I-beam 206 of the first I-beam 202 and the second I-beam 204. The operator may then stop lowering the pallet lifting assembly when the U-shaped plate 140 is resting on the floor 59.

The manufacturer may provide the second embodiment of the pallet lifting assembly 201 to the operator. The manufacturer may ensure that the lifting mechanism 142 and the trolley system 144 are attached to the U-shaped base 138. The manufacturer may also ensure that the beam 200 is attached to the lifting mechanism 142 and the U-shaped plate 140. The manufacturer may ensure that the pallet retention device 216 is secured to the U-shaped plate 140. The manufacturer may further ensure that the U-shaped plate 140 is sized correctly to sit inside of the U-shaped base 138.

FIG. 13 depicts a third embodiment of a pallet lifting assembly 301 that may include a U-shaped base 138, a U-shaped plate 140, a lifting mechanism 142, and a guide system 146.

The third embodiment of the pallet lifting assembly 301 is substantially similar to the second embodiment except the third embodiment does not include a trolley system. The third embodiment of the pallet lifting assembly 301 includes the U-shaped base 138 which includes a top surface 148, and a bottom surface 150, and a peripheral wall 152 that is defined by the thickness of the U-shaped base 138 extending between the top surface 148 and the bottom surface 150. The U-shaped base 138 further includes a first leg 154 and a second leg 156 defining there between a lateral direction. First leg 154 and second leg 156 are parallel to each other and extend between their respective forward and rear ends. First leg 154 and second leg 156 are connected by a rear leg 158, wherein the first leg 154 and the second leg 156 create a mirror image of each other along a center axis 160 on the rear leg 158. The bottom surface 150 of U-shaped base 138 rests directly on the floor 59 and in another embodiment may be secured to the floor 59.

The third embodiment of the pallet lifting assembly 301 includes the U-shaped plate 140. The U-shaped plate 140 includes a top surface 162, and a bottom surface 164, and a peripheral wall 166 that is defined by the thickness of the U-shaped plate 140 extending between the top surface 162 and the bottom surface 164. The U-shaped plate 140 further includes a first leg 168 and a second leg 170 defining there between a lateral direction. First leg 168 and second leg 170 are connected by a rear leg 172, wherein the first leg 168 and the second leg 170 create a mirror image of each other along the center axis 160 on the rear leg 172. U-shaped plate 140 further includes a first wall section 174 that extends from the first leg 168, a second wall section 176 that extends from the second leg 170, wherein the first wall section 174 and the second wall section 176 are each downwardly facing L-shaped wall sections. U-shaped plate 140 includes a rear wall section 178 that extends from the rear leg 172 wherein the rear wall section 178 is an upwardly facing L-shaped wall section which has an interior surface 177 and an exterior surface 179. The U-shaped plate 140 includes at least one gusset 180 that may secure the first wall section 174 and/or the second wall section 176 and/or the rear wall section 178 to the top surface 162 of the U-shaped plate 140. At the forward end of the first leg 168 and the second leg 170 there is a sloped surface 184. A lifting region 184 is defined by an arrow 186 which depicts the width of the lifting region 184 and an arrow 188 which depicts the length of the lifting region 184.

In the third embodiment the U-shaped base 138 and U-shaped plate 140 are configured to work in conjunction with one another similar to what is shown in FIG. 9. U-shaped base 138 may be mounted on the floor 59 or rest on the floor 59 and when U-shaped plate 140 is in its lowered position the U-shaped plate 140 rests inside of the U-shaped base 138. The U-shaped base 138 remains stationary while the U-shaped plate 140 may move to a raised and lowered position.

The third embodiment of the pallet lifting assembly 301 includes the lifting mechanism 142, wherein the lifting mechanism 142 includes a main body 190 and a mount 192 wherein the mount 192 is connected to the main body 190. The lifting mechanism 142 further includes an actuator 193 composed of a cylinder 194 and an extension rod 196 wherein the extension rod 196 is inside of the cylinder 194 when the pallet lifting assembly 201 is at its lowered position. The extension rod 196 may extend out of the cylinder 194 when the pallet lifting assembly 201 is in a raised position. The lifting mechanism 142 further includes a connector 198 and a beam 200 wherein the connector 198 secures the extension rod 196 to the beam 200 so that the beam 200 and the extension rod 196 move in tandem. In the second embodiment of the pallet lifting assembly 201 a motor 191 of the main body 190 may rotate the extension rod 196 therefore causing the extension rod 196 and the beam 200 to rise. The motor 191 of main body 190 may also reverse the rotation of the extension rod 196 therefore allowing the extension rod 196 and the beam 200 to be lowered. Alternatively, a hydraulic actuator may be used, or the actuator may be an electric actuator.

In the third embodiment the lifting mechanism 142 may be attached to the U-shaped base 138 and the U-shaped plate 140. The lifting mechanism 142 is attached to the U-shaped base 138 with the mount 192 mounted on the top surface 148 of the rear leg 158 of the U-shaped base 138. The lifting mechanism 142 is attached to the U-shaped plate 140 by the connector 198 secured to the beam 200 which is secured to the exterior surface 179 of the rear wall section 178 of the U-shaped plate 140. In the third embodiment of pallet lifting assembly 301 the lifting mechanism 142 acts as a lift and as a guide as the third embodiment does not have any I-beams to help guide the U-shaped plate 140 as it is raised and lowered.

The third embodiment of the pallet lifting assembly may include a guide system 146. Guide system 146 has at least one pallet retention device 216. The at least one pallet retention device 216 has a first wall section 218 and a second wall section 220 that are orthogonal to one another wherein the first wall section 218 and the second wall section are different lengths. The at least one pallet retention device 216 has a third wall section 222 and a fourth wall section 224 wherein the third wall section 222 and the fourth wall section 224 are orthogonal to one another and wherein the third wall section 222 and the fourth wall section 224 are different lengths. The at least one pallet retention device 216 has a fifth wall section 226 and a sixth wall section 228 wherein the fifth wall section 226 and the sixth wall section 228 are orthogonal to one another and wherein the fifth wall section 226 and the sixth wall section are different lengths. The at least one pallet retention device 216 has a seventh wall section 230 and an eighth wall section 232 wherein the seventh wall section 230 and the eighth wall section 232 are orthogonal to one another and wherein the seventh wall section 230 and the eighth wall section 232 are different lengths. The at least one pallet retention device 216 has a ninth wall section 234 that is at an angle between 90 degrees and 180 degrees in relation to the eighth wall section 232. First wall section 218, third wall section 222, fifth wall section 226, and seventh wall section 230 are all parallel to one another and perpendicular to the second wall section 220, fourth wall section 224, sixth wall section 228, and eighth wall section 232 that are all parallel to one another. The at least one pallet retention device 216 further includes a first upwardly facing top surface 236 that connects to an exterior surface 238 and an interior surface 240. The at least one pallet retention device 216 includes a second upwardly facing top surface 242 that is orthogonal to the exterior surface 238. The at least one pallet retention device 216 includes a peripheral wall 244 that extends around the perimeter of the at least one pallet retention device 216 and connects to the bottom surface 246 of the at least one pallet retention device 216. The first upwardly facing top surface 236, exterior surface 238, interior surface 240, second upwardly facing top surface 242, peripheral wall 244, and bottom surface 246 collectively extend from the first wall section 218 through the ninth wall section 234.

Similar to FIG. 11, the third embodiment of the pallet lifting assembly 301 may contain the at least one pallet retention device 216 attached to the U-shaped plate 140. The bottom surface 246 of the at least one pallet retention device 216 is connected to the top surface 162 of the U-shaped plate 140. The at least one pallet retention device 216 may work with a first pallet 122 (shown in FIG. 11A) or work with a second pallet 124 (shown in FIG. 11B). In the present embodiment of pallet lifting assembly 301 two pallet retention devices 216 are shown and the pallet retention device 216 may work with any sized pallet that the pallet retention device 216 can support.

Having now described the components and parts of the third embodiment of the pallet lifting assembly 301, methods of lifting pallets with the pallet lifting assembly 301 are discussed in greater detail below.

An operator may find space within their workstation whether it is a warehouse or another area that is clear of other items, the customer may install the third embodiment of pallet lifting assembly 301 to the floor 59. When the pallet lifting assembly 301 is placed on the floor 59 the U-shaped base 138 will rest on the floor 59 and/or be secured to the floor 59 and remain stationary whether the pallet lifting assembly 301 is in the raised position or in its lowered position. Further, when the pallet lifting assembly 301 is in its lowered position the U-shaped plate 140 also rests on the floor 59. The thickness of U-shaped plate 140 is defined by the peripheral wall 166 which is sufficiently low so that a pallet jack can deliver a pallet to the pallet lifting assembly. In one exemplary embodiment the thickness of the U-shaped plate 140 may be ¼″. The U-shaped plate 140 further includes a sloped surface 182 on the front end of the first leg 168 and the second leg 170 which may allow even more ease to deliver a pallet to the pallet lifting assembly 301. The U-shaped plate 140 may be raised and lowered as the operator needs while the U-shaped base 138 remains on the floor 59 with the lifting mechanism 142 attached thereto.

In operation, the operator may assemble the second embodiment of the pallet lifting assembly 301 by securing the U-shaped base 138 to the floor 59 to ensure it is stable and does not move during operation. Next, the operator may ensure that the U-shaped plate 140 is in the lowered position so that the bottom surface 164 is resting on the floor 59. The operator may then find a desired pallet 122 and the operator may use a pallet jack to lift the pallet 122 onto the lifting region 184 of the U-shaped plate 140. The pallet 122 may be sized by the operator using the guide system 146. When the operator uses the guide system 146, they may place the pallet 122 against at least one of the wall sections of at least one pallet retention device 216. In one exemplary embodiment the pallet 124 is resting against the first wall section 218 and the second wall section 220. In another exemplary embodiment the pallet 122 may rest against the seventh wall section 230 and the eighth wall section 232. In yet another exemplary embodiment a pallet of a different size may rest against the third wall section 222 and the fourth wall section 224. In yet another exemplary embodiment an additional pallet of a different size may rest against the fifth wall section 226 and the sixth wall section 228. In yet another exemplary embodiment a pallet of a non-traditional size/shape may rest against the ninth wall section 234. In another exemplary embodiment a pallet may rest against any combination of the wall sections on the pallet retention device 216.

Following the placement of the pallet 122 on the lifting region 184 of the third embodiment of the pallet lifting assembly 301 the operator may then begin to raise the pallet lifting assembly. To raise a portion of the pallet lifting assembly 301 the operator may initiate the motor 191. As the motor 191 rotates the extension rod 196 inside the cylinder 194 the extension rod 196 begins to move in a vertical direction. As the extension rod 196 moves in a vertical direction the trolley system 144 beings to move in tandem with the lifting mechanism 142. The first pair of wheels 208 and the second pair of wheels 210 may move in a vertical direction along the first I-beam 202 and the second I-beam 204. The operator may stop the lifting mechanism 142 when the pallet lifting assembly 201 has reached a desired height. Alternatively, a sensor can be used to automatically stop the lifting mechanism when the pallet reaches its desired height.

Once the operator has determined the pallet lifting assembly 301 is at the desired height, the AMR 130 may drive under the pallet lifting assembly 301 similar to what is shown in FIG. 8C and FIG. 8D in the first embodiment. Once the AMR 130 is under pallet lifting assembly 301, the AMR 130 will be centered under the part of the pallet 122 that is not supported by the lifting region 184 of the U-shaped plate 140 similar to what is shown in FIG. 8E of the first embodiment. The AMR 130 may then receive the pallet 122 by the pallet lifting assembly 301 lowering the pallet 122 onto the AMR 130. The operator may lower the pallet lifting assembly 201 by reversing the direction of the motor 191 causing the extension rod 196 to move in a downward direction allowing the AMR 130 to receive the pallet 122 from the U-shaped plate 140. The pallet lifting assembly 301 may also have a sensor that is able to detect when the AMR 130 is underneath the pallet lifting assembly 201 and automatically lower itself onto the AMR 130. The AMR 130 may be able to fit inside the perimeter of the U-shaped base 138 so that it may receive the pallet 122 without the lifting mechanism 142 obstructing the transfer of the pallet 122 from the U-shaped plate 140 to the AMR 130. In another exemplary embodiment the AMR 130 may be capable of raising and lowering itself to receive pallet 122. Once the AMR 130 is loaded with the pallet 122 the AMR 130 may drive away similar to what is shown in FIG. 8G in the first embodiment. The AMR 130 may take the pallet 122 to the desired location of the operator.

Next, the operator may lower the pallet lifting assembly 301 to its lowered position by releasing the pressure from inside the cylinder 194. As the pressure is released the extension rod 196 will begin to retract into the cylinder 194 therefore lowering the pallet lifting assembly 301. The operator may then stop lowering the pallet lifting assembly when the U-shaped plate 140 is resting on the floor 59.

The manufacturer may provide the second embodiment of the pallet lifting assembly 301 to the operator. The manufacturer may ensure that the lifting mechanism 142 is attached to the U-shaped base 138. The manufacturer may also ensure that the beam 200 is attached to the lifting mechanism 142 and the U-shaped plate 140. The manufacturer may ensure that the pallet retention device 216 is secured to the U-shaped plate 140. The manufacturer may further ensure that the U-shaped plate 140 is sized correctly to sit inside of the U-shaped base 138.

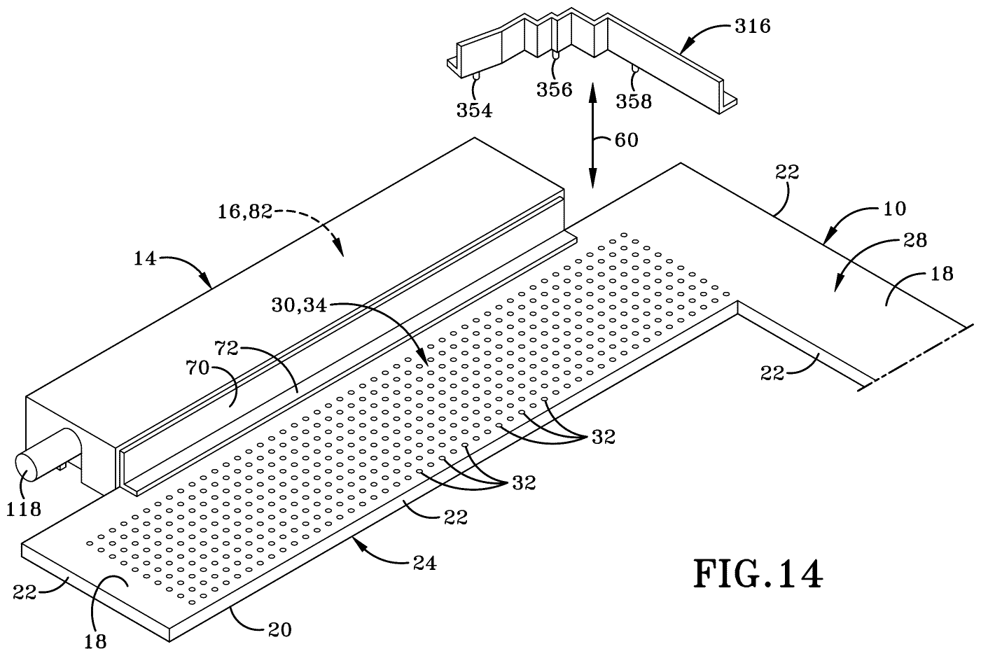

FIG. 14 depicts an alternative embodiment. The alternative embodiment is substantially similar to the above listed embodiments and may combine elements from pallet lifting assembly 1, 201, and 301. The alternative embodiment may include a pallet retention device 316 wherein the pallet retention device 316 is substantially similar to pallet retention device 216 except the addition of at least two prongs. In the alternative embodiment a first prong 354, a second prong 356, and a third prong 358 are shown. The prongs 354, 356, and 358 allow the pallet retention device 316 to be inserted and removed from the peg board surface 30 of the U-shaped receiver 10.

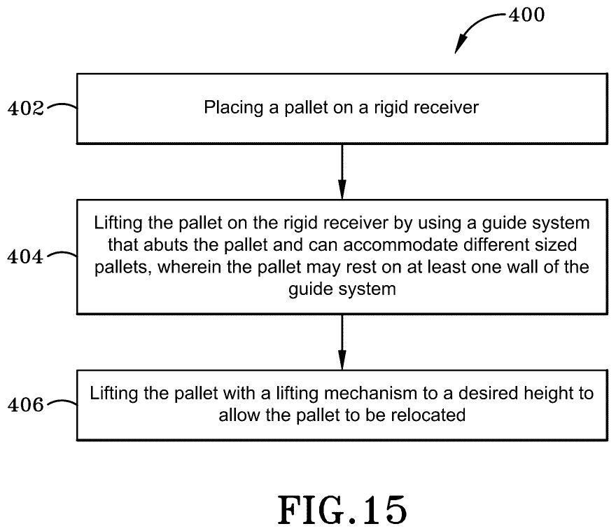

FIG. 15 shows a first method flow chart shown generally as 400. The first method flow chart 400 describes how to use the pallet lifting assembly 1, 201, and 301. Placing a pallet on a rigid receiver 402, lifting the pallet on the rigid receiver by using a guide system that abuts the pallet and can accommodate different sized pallets, wherein the pallet may rest on at least one wall of the guide system 404, lifting the pallet with a lifting mechanism to a desired height to allow the pallet to be relocated. 406.

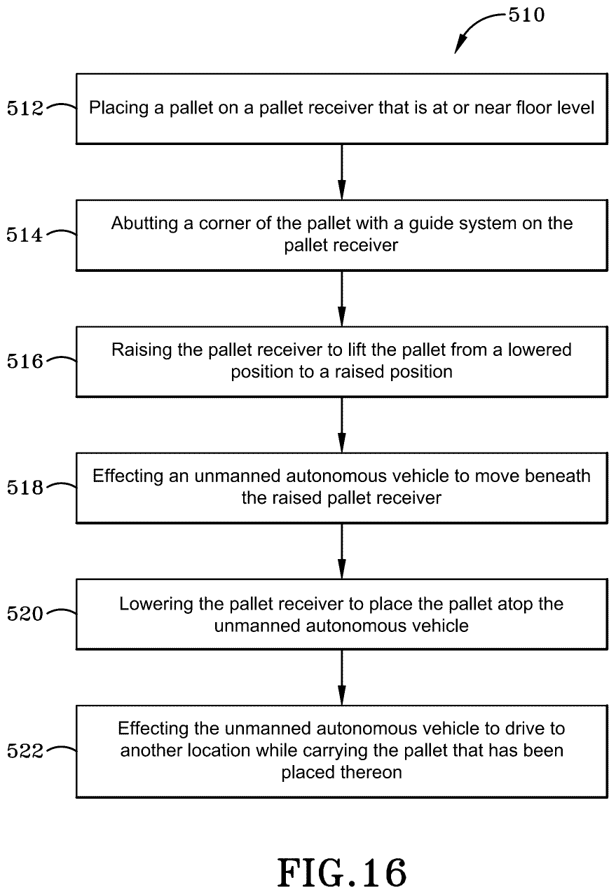

FIG. 16 shows a second method flow chart shown generally as 510. The second method flow chart 510 describes placing a pallet on a pallet receiver that is at or near floor level 512; abutting a corner of the pallet with a guide system on the pallet receiver 514; raising the pallet receiver to lift the pallet from a lowered position to a raised position 516; effecting an unmanned autonomous vehicle to move beneath the raised pallet receiver 518; lowering the pallet receiver to place the pallet atop the unmanned autonomous vehicle 520; and effecting the unmanned autonomous vehicle to drive to another location while carrying the pallet that has been placed thereon 522.

In another exemplary embodiment the present disclosure may include placement walls or retention walls that are automated. The placement walls may assist in securing the pallet and items onto the pallet lifting assembly and may provide more stability when the pallet lifting assembly 1, 201, and 301 are transferring the pallet to the AMR 130. In other words, placement walls may be automatic side arms that may close to adjust to a pallet size. A sensor, laser, camera, or any other sensing device may detect the pallet width and then the sensor may allow the automatic side arms to release from a stored position to an extended position to fit the size of the pallet. An operator may also input the dimensions of the pallet which would allow the automatic side arms to extend to the width provided by an operator.

The pallet lifting assembly 1, 201, and 301 may be equipped with either lifting mechanism shown in the pallet lifting assembly 1, 201, and 301 namely lifting jack 16, lifting mechanism 142 with trolley system 144, or lifting mechanism 142 without trolley system 144. Further the pallet lifting assembly 1, 201, and 301 may be equipped with any lifting mechanism configuration not shown.

The assembly of the present disclosure may additionally include one or more sensors to sense or gather data pertaining to the surrounding environment or operation of the assembly. Some exemplary sensors capable of being electronically coupled with the assembly of the present disclosure (either directly connected to the assembly of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels. In the present disclosure there may be cameras to see a QR Code or a barcode. In the present disclosure there may also be an RF tag reader which may identify the AMR is in position under the pallet lifting assembly 1, 201, 301. In the present disclosure the sensors may be used to tell the pallet lifting assembly 301 when the AMR 130 is below and ready to receive the pallet. Another sensor on the AMR may be able to tell if the load that is about to be placed on the AMR if it is unstable and whether or not it is safe to proceed with the desired pick up. An additional sensor may communicate between the pallet lifting assembly 1, 201, and 301 with the AMR to be able to communicate to the AMR the size and the weight of the pallet.

If sensors are utilized to gather data relating to the assembly of the present disclosure, then sensed data may be evaluated and processed with artificial intelligence (AI). Analyzing data gathered from sensors using artificial intelligence involves the process of extracting meaningful insights and patterns from raw sensor data to produce refined and actionable results. Raw data is gathered from various sensors, for example those which have been identified herein or others, capturing relevant information based on the intended analysis. This data is then preprocessed to clean, organize, and structure it for effective analysis. Features that represent key characteristics or attributes of the data are extracted. These features serve as inputs for Al algorithms, encapsulating relevant information essential for the analysis. A suitable Al model, such as machine learning or deep learning (regardless of whether it is supervised or unsupervised), is chosen based on the nature of the data and the desired analysis outcome. The model is then trained using labeled or unlabeled data to learn the underlying patterns and relationships. The model is fine-tuned and optimized to enhance its performance and accuracy. This process involves adjusting parameters, architectures, and algorithms to achieve better results. The trained model is used to make predictions or inferences on new, unseen data. The model processes the extracted features and generates refined output based on the patterns it has learned during training. The results produced by the Al model are refined through post-processing techniques to ensure accuracy and relevance. These refined results are then interpreted to extract meaningful insights and derive actionable conclusions. In the present disclosure the results of whether or not a load on top of an AMR is safe is one example of meaningful insights Al may provide in the present disclosure. Feedback from the refined results is used to improve the AI model iteratively. The process involves incorporating new data, adjusting the model, and enhancing the analysis based on real-world feedback and evolving requirements. Further, Al results can be used to alter the operation of the assembly, assembly, or system of the present disclosure based on feedback. For example, Al feedback can be used to improve the efficiency of the device, assembly, or system of the present disclosure by responding to predicted changes in the environment or predicted changes to the device, assembly, or system of the present disclosure more quickly than if only sensed by one or more of the sensors.

A sensor model may be employed, once trained, in the assembly of the present disclosure. In one embodiment, the assembly of the present disclosure can be used to teach a sensor model to predict sensor data for a specific scenario. Alternatively, sensor models can be utilized to generate the data to train the Al. The sensor model can be trained for any type of sensor, such as those types of sensors described above, and/or other sensor types. One scenario that the present disclosure may address is if the load is not balanced or too heavy for the AMR/AGV. The Al can be trained to require human intervention if the Al determines that the load is unsafe for the AMR/AGV to carry. Further the AMR may have Al of its own that can be trained to self-level and solve the problem on its own. The elements described herein may be implemented as discrete or distributed components in any suitable combination and location. The various functions described herein may be conducted by hardware, firmware, and/or software. For example, a processor may perform various functions by executing instructions stored in memory.

The AI model and/or sensor model can include a deep neural network (DNN), convolutional neural network (CNN), another neural network (NN) or the like and can support generative learning. For example, the sensor model can include a generative adversarial network (GAN), a variational autoencoder (VAE), and/or another type of DNN, CNN, NN or machine learning model (e.g., natural language processing (NLP)). Generally, the sensor model can accept some encoded representation of a scene as input using any number of data structures and/or channels (e.g., concatenated vectors, matrices, tensors, images, etc.).

In a particular embodiment, the assembly of the present disclosure can use the sensors to acquire a representation of the real-world environment (e.g., a physical environment) at a given point in time. Data from these sensors may be used to generate a representation of a scene or scenario, which may then be used to teach a sensor model. For example, a representation of a scene can be derived from sensor data, properties of objects in the scene or surrounding environment such as positions or dimensions (e.g., depth maps), classification data identifying objects in the scene or surrounding environment, properties or classification data of components of the assembly of the present disclosure, items on pallets, a pallet assembly 1, 201, 301, pallet on an AMR, or some combination thereof. Generally, the sensor model learns to predict sensor data from a representation of the scene, environment or operation of the assembly of the present disclosure.

The sensor model architecture can be selected to fit the shape of the desired input and output data. Examples of architectures (e.g., DNNs) include, but are not limited to, perceptron, feed-forward, radial basis, deep feed-forward, recurrent, long/short term memory, gated recurrent unit, autoencoder, variational autoencoder, convolutional, deconvolutional, and generative adversarial. Some DNN architectures, such as a GAN, can include a convolutional neural network (CNN) that accepts and evaluates an input image and may include multiple input channels, which may be used to accept and evaluate multiple input images and/or input vectors.

In one embodiment, training data for the sensor model may be generated using real-world (e.g., physical environment) data. To collect real-world training data, the assembly of the present disclosure may collect sensor data by fusing sensors as the vehicle traverses a real-world environment. The sensors of the assembly of the present disclosure may include, for example, one or more global navigation satellite systems sensors (e.g., Global Positioning System sensors (GPS)), RADAR sensors, ultrasonic sensors, LIDAR sensors, inertial measurement unit (IMU) sensors (e.g., accelerometer(s), gyroscope(s), magnetic compass(es), magnetometer(s), etc.), ego-motion sensors, microphones, stereo cameras, wide-view cameras (e.g., fisheye cameras), infrared cameras, surround cameras (e.g., 360 degree cameras), long-range and/or mid-range cameras, speed sensors (e.g., for measuring the speed of the vehicle), vibration sensors, steering sensors, brake sensors (e.g., as part of the brake sensor system), and/or other sensor types.

In another embodiment, training data for the sensor model is generated based on simulated or virtual environments. The training data may then be used to train the sensor model for use in real-world autonomous applications, e.g., to control the operation of the assembly of the present disclosure. The training data may be derived to fit the shape of the input and output data for the sensor model, which may depend on the architecture of the sensor model. For example, sensor data may be used to encode an input scene, input parameters, and/or ground truth sensor data using different data structures and/or channels (e.g., concatenated vectors, matrices, tensors, images, etc.).

The assembly of the present disclosure may include hardware, software and/or firmware responsible for managing the sensor data generated by the sensors. The autonomous hardware, software, and/or firmware being executed may manage different environments using one or more maps (e.g., 3D maps), positioning component(s), and the like. The autonomous hardware, software, and/or firmware may also include components to plan, control, and generally manage the assembly of the present disclosure. In one example, the autonomous hardware, software, and/or firmware can be installed in and used to control the assembly of the present disclosure through the environment based on the sensor data, one or more machine learning models (e.g., neural networks), and the like. A training system may use the training data to train the sensor model to predict virtual sensor data for a given scene, environment, or operation of a component.

The training system can include one or more servers (e.g., a graphics processing unit server) and data stores and may use a cloud-based deep learning infrastructure with artificial intelligence to analyze the sensor data received from the assembly of the present disclosure and/or stored in the data store. The training system can also incorporate or train up-to-date, real-time neural networks (and/or other machine learning models) for one or more sensor models.

The assembly of the present disclosure may include wireless communication logic coupled to sensors on the assembly. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the device, assembly, or system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the assemblies of the present disclosure may serve as a repeater, or the assemblies of the present disclosure may be connected together in a mesh network to relay signals from one assembly to the next. However, the individual assembly in this scheme typically would not have IP addresses of their own. Instead, one or more of the assemblies of the present disclosure communicate with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

The system that receives and processes signals from the assembly of the present disclosure may differ from embodiment to embodiment. In one embodiment, alerts and signals from the assembly of the present disclosure are sent through an e-mail or simple message service (SMS; text message) gateway so that they can be sent as e-mails or SMS text messages to a remote device, such as a smartphone, laptop, or tablet computer, monitored by a responsible individual, group of individuals, or department, such as an operator. Thus, if a particular assembly of the present disclosure creates an alert because of a data point gathered by one or more sensors, that alert can be sent, in e-mail or SMS form, directly to the individual responsible for fixing it. Of course, e-mail and SMS are only two examples of communication methods that may be used; in other embodiments, different forms of communication may be used.

In other embodiments, alerts and other data from the sensors on the assembly of the present disclosure may also be sent to a work tracking system that allows the individual, or the organization for which he or she works, to track the status of the various alerts that are received, to schedule particular workers to repair a particular assembly of the present disclosure, and to track the status of those repair jobs. A work tracking system would typically be a server, such as a Web server, which provides an interface individuals and organizations can use, typically through the communication network. In addition to its work tracking functions, the work tracker may allow broader data logging and analysis functions. A tracker may also be set up through a QR code at a station where the present disclosure is located. For example, operational data may be calculated from the data collected by the sensors on the assembly of the present disclosure, and the system may be able to provide aggregate machine operational data for a assembly of the present disclosure or group of assemblies of the present disclosure.

The system also allows individuals to access the assembly of the present disclosure for configuration and diagnostic purposes. In that case, the individual processors or microcontrollers of the assembly of the present disclosure may be configured to act as Web servers that use a protocol like hypertext transfer protocol (HTTP) to provide an online interface that can be used to configure the assembly. In some embodiments, the systems may be used to configure several assemblies of the present disclosure at once. For example, if several assemblies are of the same model and are in similar locations in the same location, it may not be necessary to configure the assemblies individually. Instead, an individual may provide configuration information, including baseline operational parameters, for several assemblies at once.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Unless explicitly stated that a particular shape or configuration of a component is mandatory, any of the elements, components, or structures discussed herein may take the form of any shape. Thus, although the figures depict the various elements, components, or structures of the present disclosure according to one or more exemplary embodiments, it is to be understood that any other geometric configuration of that element, component, or structure is entirely possible. For example, instead of the markers being circular dots, the markers 22 can be semi-circular triangular, rectangular or square, pentagonal, hexagonal, heptagonal, octagonal, decagonal, dodecagonal, diamond shaped or another parallelogram, trapezoidal, star-shaped, oval, ovoid, lines or lined, teardrop-shaped, cross-shaped, donut-shaped, heart-shaped, arrow-shaped, crescent-shaped, any letter shape (i.e., A-shaped, B-shaped, C-shaped, D-shaped, E-shaped, F-shaped, G-shaped, H-shaped, I-shaped, J-shaped, K-shaped, L-shaped, M-shaped, N-shaped, O-shaped, P-shaped, Q-shaped, R-shaped, S-shaped, T-shaped, U-shaped, V-shaped, W-shaped, X-shaped, Y-shaped, or Z-shaped), or any other type of regular or irregular, symmetrical or asymmetrical configuration.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, firmware or a combination thereof. When implemented in software, the software code or instructions can be executed on any suitable processor or collection of processors, whether provided in a single computer or distributed among multiple computers or in firmware. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that are executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

The term “at floor level” or “closely adjacent to the floor level” and derivatives thereof (e.g., “at or near floor level”) refer to the receiver being placed on the ground/floor of a facility (typically made from concrete) or at a lowermost limit that is slightly above the floor, typically such that the upper surface of the receiver is no more than about 4 inches from the floor due the thickness of the receiver.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present disclosure.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments. Furthermore, the use of any and all examples or exemplary language (“e.g.,” “such as,” or the like) is intended merely to better illustrate or illuminate the embodiments and does not pose a limitation on the scope of that or those embodiments. No language in this specification should be construed as indicating any unclaimed element as essential to the practice of the disclosed embodiment.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein. Further, recitation of ranges of values herein are not intended to be limiting, referring instead individually to any and all values falling within that range, unless otherwise indicated herein, and each separate value within such range is incorporated into the specification as if it were individually recited herein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of document word submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A pallet lifting assembly comprising:
a pallet receiver positioned at or closely adjacent to floor level, wherein the pallet receiver is configured to receive at least one pallet thereon, wherein the pallet is adapted to support items thereon once received by the pallet receiver;
a guide system on the pallet receiver that accommodates placement of different sized pallets on the pallet receiver; and
a lifting mechanism to raise the pallet receiver from floor level to a sufficient height that permits unmanned autonomous vehicle to move beneath the pallet receiver and the receiver be lowered to place the pallet atop the unmanned autonomous vehicle.

2. The pallet lifting assembly of claim 1, wherein the lifting mechanism is located at a perimeter of the pallet receiver.

3. The pallet lifting assembly of claim 1, further comprising:
a pegboard surface on the pallet receiver, wherein the pegboard surface has a number of apertures defined in the pallet receiver, wherein the apertures extend from a top surface of the pallet receiver toward a bottom surface of the pallet receiver.

4. The pallet lifting assembly of claim 3, wherein the guide system includes at least a first wall section and a second wall section that are oriented at a right angle relative to each other and define a corner brace that is configured to receive a corner of the pallet therebetween.

5. The pallet lifting assembly of claim 4, wherein the corner brace comprises at least two prongs, wherein the two prongs extend downwardly from a bottom surface of the corner brace.

6. The pallet lifting assembly of claim 5, wherein the at least two prongs have a generally cylindrical shape, wherein a diameter of each prong is marginally less than a diameter of the apertures on the pegboard surface such that the prongs are configured to fit in the apertures to attach the corner brace to the pegboard surface.

7. The pallet lifting assembly of claim 1, further comprising:
a trolley; and
at least one rail that extends vertically upward relative to the pallet receiver that is oriented flat at or near floor level, wherein the trolley rides along the at least one rail as the pallet receiver is raised and lowered.

8. The pallet lifting assembly of claim 7, further comprising:
a second trolley; and
a second rail that extends vertically upward relative to the receiver that is oriented flat at or near floor level, wherein the second trolley rides along the second rail as the pallet receiver is raised and lowered.

9. The pallet lifting assembly of claim 7, wherein the pallet receiver is U-shaped and composed of first and second parallel legs and a rear leg that extends between the first and second parallel legs, and the trolley and the first rail are positioned adjacent the rear leg of the pallet receiver.

10. The pallet lifting assembly of claim 1, wherein the guide system further comprises at least one retention brace.

11. The pallet lifting assembly of claim 10, wherein the at least one retention brace comprises:
a first wall section; and
a second wall section, wherein the first wall section and the second wall section are connected and orthogonal to one another and wherein the first wall section and the second wall section differ in length.

12. The pallet lifting assembly of claim 11, wherein the at least one retention brace further comprises:
a third wall section that is connected to the second wall section; and
a fourth wall section, wherein the third wall section and the fourth wall section are connected and orthogonal to one another and wherein the third wall section and the fourth wall section differ in length.

13. The pallet lifting assembly of claim 12, wherein the at least one retention brace further comprises:
a fifth wall section that is connected to the fourth wall section; and
a sixth wall section wherein the fifth wall section and the sixth wall section are connected and orthogonal to one another and wherein the fifth wall section and the sixth wall section differ in lengths;
a seventh wall section connected to the sixth wall section;
an eighth wall section wherein the seventh wall section and the eighth wall section are connected and orthogonal to one another and wherein the seventh wall section and the eighth wall section differ in length; and
a ninth wall section that connected to the eighth wall section and is at an angle between about 90 degrees and about 180 degrees relative to the eighth wall section.

14. The pallet lifting assembly of claim 10, wherein the at least one retention brace is in a fixed position on a top surface of the pallet receiver.

15. A method for lifting a pallet onto an unmanned autonomous vehicle, the method comprising:
placing a pallet on a pallet receiver that is at or near floor level;
abutting a corner of the pallet with a guide system on the pallet receiver;
raising the pallet receiver to lift the pallet from a lowered position to a raised position;
effecting an unmanned autonomous vehicle to move beneath the raised pallet receiver;
lowering the pallet receiver to place the pallet atop the unmanned autonomous vehicle; and
effecting the unmanned autonomous vehicle to drive to another location while carrying the pallet that has been placed thereon.

16. The method of claim 15, further comprising:
selectively adjusting the guide system prior to placing the pallet on the pallet receiver, wherein adjusting the guide system is accomplished by inserting at least two prongs of a corner brace of the guide system into a pegboard surface on the rigid receiver.

17. The method of claim 15, wherein abutting the corner of the pallet with a guide system is accomplished by contacting the corner of the pallet with two orthogonal walls of differing length that in a fixed position on a top surface of the pallet receiver.

18. The method of claim 15, further comprising:
moving a trolley along a rail that are in operative communication with the pallet receiver as the pallet received is raised and lowered.

19. The method of claim 15, wherein raising the pallet receiver is accomplished by moving a set of jacks that are located on each side of the pallet receiver.

20. The method of claim 15, wherein raising the pallet receiver is accomplished by rotating a threaded drive rod that is vertically oriented and located near a perimeter of the pallet receiver.
